(19) United States
(12) Patent Application Publication
(10) Pub. No.: US 2022/0210838 A1
(43) Pub. Date: Jun. 30, 2022

(54) SUPPORTING RANDOM ACCESS TYPE SELECTION BY A USER EQUIPMENT

(71) Applicant: Qualcomm Incorporated, San Diego, CA (US)

(72) Inventors: Jing LEI, San Diego, CA (US); Wanshi CHEN, San Diego, CA (US); Joseph Binamira SORIAGA, San Diego, CA (US); Peter GAAL, San Diego, CA (US); Rulming ZHENG, San Diego, CA (US); Lihhai HE, San Diego, CA (US); Seyong PARK, San Diego, CA (US); Naga BHUSHAN, San Diego, CA (US); Ozcan OZTURK, San Diego, CA (US)

(21) Appl. No.: 17/606,988

(22) PCT Filed: May 8, 2020
(86) PCT No.: PCT/CN2020/089135

§ 371 Date: Oct. 27, 2021

(30) Foreign Application Priority Data
May 10, 2019 (CN) PCT/CN2019/086443

(51) Int. Cl. H04W 74/08; H04W 24/08; H04L 5/00; H04W 74/00

(52) U.S. Cl. CPC H04W 74/0833; H04W 74/002; H04L 5/0048; H04W 24/08

(57) ABSTRACT

Methods, systems, and devices for wireless communications are described. Generally, the described techniques provide for a user equipment (UE) receiving a configuration message from a base station for supporting random access channel (RACH) type selection by the UE. The configuration message may include one or more reference signals and one or more link quality thresholds corresponding to the one or more reference signals. The UE may generate measurements of the reference signals and determine link quality for communications between the UE and the base station based on the measurements. Based on a comparison between the link quality to corresponding link quality thresholds, the UE may select a two-step random access procedure, a four-step random access procedure, or both for establishing a connection with the base station. In some cases, the UE considers system loading information, transmission parameters, or random access rules in selecting the random access procedure.

### CROSS-REFERENCE TO RELATED APPLICATIONS

The present Application is a 371 national stage filing of International Patent No. PCT/CN2020/089135 by LEI et al., entitled “SUPPORTING RANDOM ACCESS TYPE SELECTION BY A USER EQUIPMENT,” filed May 8, 2020 and claims priority to International Patent Application No. PCT/CN2019/086443 by LEI et al., entitled “SUPPORTING RANDOM ACCESS TYPE SELECTION BY A USER EQUIPMENT,” filed May 10, 2019, each of which is assigned to the assignee hereof, and each of which is expressly incorporated by reference in its entirety herein.

### BACKGROUND

The following relates generally to wireless communications, and more specifically to procedures and signaling support for random access channel (RACH) type selection.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

A wireless multiple-access communications system may include a number of base stations or network access nodes, each simultaneously supporting communication for multiple communication devices, which may be otherwise known as user equipment (UE). When connecting to a base station to receive and/or transmit subsequent communications, a UE may perform a RACH procedure to establish the connection with the base station. A UE may utilize one or more different RACH procedure types to establish the connection, but one RACH procedure type may perform less efficiently relative to another RACH procedure type in some circumstances.

### SUMMARY

The described techniques relate to improved methods, systems, devices, and apparatuses that support a supports procedures and signaling support for random access channel (RACH) type selection. Generally, the described techniques provide for a user equipment (UE) receiving a configuration message from a base station for supporting RACH type selection by the UE. In some cases, the configuration message may include one or more reference signals and one or more link quality thresholds corresponding to the one or more reference signals. The UE may generate measurements of the one or more reference signals and determine link quality for communications between the UE and the base station based on the measurements. Based on a comparison between the link quality to corresponding link quality thresholds, the UE may select a two-step random access procedure, a four-step random access procedure, or both for establishing a connection with the base station, based at least in part on whether the link quality satisfies the at least one of the one or more link quality thresholds. In some cases, the UE may also consider its capability of supporting transmission parameters received from the base station when selecting the RACH procedure. Also, in some cases, the UE may consider system loading information received from the base station when selecting the RACH procedure.

The techniques also provide for a UE participating in a random access procedure for establishing a connection with the base station for a plurality of logical channels that have different quality of service levels. The described techniques provide for a UE receiving a configuration message from a base station for supporting prioritization of higher priority logical channels and determining a RACH procedure. The configuration message may identify a random access rule for prioritizing, during the random access procedure, a higher priority logical channel of the plurality of logical channels. The UE may select a two-step random access procedure, a four-step random access procedure, or both based on the random access rule, to establish the connection with the base station.

A method of wireless communications at a UE is described. The method may include receiving, from a base station, a configuration message identifying one or more reference signals to be measured by the UE in determining a link quality for communications between the UE and the base station, where the configuration message also includes an identification of one or more link quality thresholds corresponding to the one or more reference signals, determining the link quality for communications between the UE and the base station based on measurements made of at least one of the one or more reference signals, comparing the link quality to a corresponding at least one of the one or more link quality thresholds, and selecting, for establishing a connection with the base station, a two-step random access procedure, a four-step random access procedure, or both based on whether the link quality satisfies the at least one of the one or more link quality thresholds.

An apparatus for wireless communications at a UE is described. The apparatus may include a processor, memory coupled with the processor, and instructions stored in the memory. The instructions may be executable by the processor to cause the apparatus to receive, from a base station, a configuration message identifying one or more reference signals to be measured by the UE in determining a link quality for communications between the UE and the base station, where the configuration message also includes an identification of one or more link quality thresholds corresponding to the one or more reference signals, determine the link quality for communications between the UE and the base station based on measurements made of at least one of the one or more reference signals, compare the link quality to a corresponding at least one of the one or more link quality thresholds, and select, for establishing a connection with the base station, a two-step random access procedure, a four-step random access procedure, or both based on whether the link quality satisfies the at least one of the one or more link quality thresholds.

Another apparatus for wireless communications at a UE is described. The apparatus may include means for receiving, from a base station, a configuration message identifying one or more reference signals to be measured by the UE in determining a link quality for communications between the UE and the base station, where the configuration message also includes an identification of one or more link quality thresholds corresponding to the one or more reference signals, determining the link quality for communications between the UE and the base station based on measurements made of at least one of the one or more reference signals, comparing the link quality to a corresponding at least one of the one or more link quality thresholds, and selecting, for establishing a connection with the base station, a two-step random access procedure, a four-step random access procedure, or both based on whether the link quality satisfies the at least one of the one or more link quality thresholds.

A non-transitory computer-readable medium storing code for wireless communications at a UE is described. The code may include instructions executable by a processor to receive, from a base station, a configuration message identifying one or more reference signals to be measured by the UE in determining a link quality for communications between the UE and the base station, where the configuration message also includes an identification of one or more link quality thresholds corresponding to the one or more reference signals, determine the link quality for communications between the UE and the base station based on measurements made of at least one of the one or more reference signals, compare the link quality to a corresponding at least one of the one or more link quality thresholds, and select, for establishing a connection with the base station, a two-step random access procedure, a four-step random access procedure, or both based on whether the link quality satisfies the at least one of the one or more link quality thresholds.

Some examples of the method, apparatuses, and non-transitory computer-readable medium described herein may further include operations, features, means, or instructions for receiving, from the base station, the configuration message identifying one or more transmission parameters for inclusion in a first message of the two-step random access procedure, where the selection of the two-step random access procedure, the four-step random access procedure, or both may be further based on determining whether the UE supports the one or more transmission parameters identified by the configuration message.

Some examples of the method, apparatuses, and non-transitory computer-readable medium described herein may further include operations, features, means, or instructions for determining that the UE supports the one or more transmission parameters, and establishing the connection via the two-step random access procedure based on determining that the UE supports the one or more transmission parameters.

Some examples of the method, apparatuses, and non-transitory computer-readable medium described herein may further include operations, features, means, or instructions for determining that the UE does not support the one or more transmission parameters, and establishing the connection via the four-step random access procedure based on determining that the UE does not support the one or more transmission parameters.

In some examples of the method, apparatuses, and non-transitory computer-readable medium described herein, the one or more transmission parameters include a modulation coding scheme, a waveform, a bandwidth, a payload size, a numerology, or a combination thereof.

Some examples of the method, apparatuses, and non-transitory computer-readable medium described herein may further include operations, features, means, or instructions for determining that the UE supports the one or more transmission parameters, where the selection of the two-step random access procedure, the four-step random access procedure, or both may be random based on determining that the UE supports the one or more transmission parameters.

Some examples of the method, apparatuses, and non-transitory computer-readable medium described herein may further include operations, features, means, or instructions for receiving, from the base station, an indication of system loading information, where the selection of the two-step random access procedure, the four-step random access procedure, or both may be further based on the indication of the system loading information.

In some examples of the method, apparatuses, and non-transitory computer-readable medium described herein, receiving the indication of system loading information may include operations, features, means, or instructions for receiving the indication as an increase or a decrease of the one or more link quality thresholds.

Some examples of the method, apparatuses, and non-transitory computer-readable medium described herein may further include operations, features, means, or instructions for receiving the indication of system loading information via radio resource control signaling.

Some examples of the method, apparatuses, and non-transitory computer-readable medium described herein may further include operations, features, means, or instructions for identifying that the random access procedure may be to be repeated, determining a quality of service associated with a logical channel for which the random access procedure may be to be repeated, and re-establishing the connection with the base station via the two-step random access procedure, the four-step random access procedure, or both based on the determined quality of service associated with the logical channel.

In some examples of the method, apparatuses, and non-transitory computer-readable medium described herein, re-establishing the connection with the base station may include operations, features, means, or instructions for re-establishing the connection with the base station via both the two-step random access procedure and the four-step random access procedure based on determining that the quality of service associated with the logical channel satisfies a quality of service threshold.

In some examples of the method, apparatuses, and non-transitory computer-readable medium described herein, re-establishing the connection with the base station may include operations, features, means, or instructions for determining an availability, a contention probability, or both associated with both the two-step random access procedure and the four-step random access procedure, and establishing the connection with the base station via the two-step random access procedure, the four-step random access procedure, or both based on the determined availability or the contention probability associated with the two-step random access procedure and the four-step random access procedure.

Some examples of the method, apparatuses, and non-transitory computer-readable medium described herein may further include operations, features, means, or instructions for determining the availability, the contention probability, or both associated with both the two-step random access procedure and the four-step random access procedure based on the quality of service associated with the logical channel.

In some examples of the method, apparatuses, and non-transitory computer-readable medium described herein, re-establishing the connection with the base station may include operations, features, means, or instructions for identifying a link quality associated with each of a set of carrier bandwidths supported by the UE, determining the quality of service associated with the logical channel, selecting one of the set of carrier bandwidths based on the determined quality of service for transmission via the logical channel and the link quality associated with each of the set of carrier bandwidths, and re-establishing the connection with the base station via the two-step random access procedure, the four-step random access procedure, or both based on whether the selected one of the set of carrier bandwidths may be associated with the two-step random access procedure or the four-step random access procedure.

In some examples of the method, apparatuses, and non-transitory computer-readable medium described herein, receiving, from the base station, the configuration message further may include operations, features, means, or instructions for receiving the configuration message via radio resource control signaling.

In some examples of the method, apparatuses, and non-transitory computer-readable medium described herein, receiving, from the base station, the configuration message further may include operations, features, means, or instructions for receiving the configuration message via system information signaling.

Some examples of the method, apparatuses, and non-transitory computer-readable medium described herein may further include operations, features, means, or instructions for receiving, from the base station, a second configuration message updating the one or more link quality thresholds corresponding to the one or more reference signals, where the selection of the two-step random access procedure, the four-step random access procedure, or both may be based on whether the link quality satisfies at least one of the one or more updated link quality thresholds.

Some examples of the method, apparatuses, and non-transitory computer-readable medium described herein may further include operations, features, means, or instructions for receiving, from the base station, a second configuration message indicating the selection of the four-step random access procedure, and establishing the connection with the base station via the four-step random access procedure based on the second configuration message.

In some examples of the method, apparatuses, and non-transitory computer-readable medium described herein, establishing the connection with the base station further may include operations, features, means, or instructions for establishing the connection via the four-step random access procedure based on the link quality not satisfying the at least one of the one or more link quality thresholds.

In some examples of the method, apparatuses, and non-transitory computer-readable medium described herein, establishing the connection with the base station further may include operations, features, means, or instructions for establishing the connection via the two-step random access procedure based on the link quality satisfying the at least one of the one or more link quality thresholds.

In some examples of the method, apparatuses, and non-transitory computer-readable medium described herein, the one or more reference signals to be measured include a synchronization signal block, a channel state information reference signal, a positioning reference signal, a system information block, or a combination thereof.

In some examples of the method, apparatuses, and non-transitory computer-readable medium described herein, determining the link quality for communications between the UE and the base station may include operations, features, means, or instructions for determining a received signal power measurement of the one or more reference signals.

A method of wireless communications at a UE is described. The method may include identifying that the UE is to participate in a random access procedure with a base station, where the random access procedure is for establishing a connection with the base station for a set of logical channels that have different quality of service levels, receiving, from the base station, a configuration message identifying a random access rule for prioritizing, during the random access procedure, a higher priority logical channel of the set of logical channels, where the higher priority logical channel has a higher quality of service level than others of the set of logical channels, selecting, for establishing the connection with the base station, a two-step random access procedure, a four-step random access procedure, or both, based on the random access rule, and establishing the connection with the base station for the higher priority logical channel in accordance with the random access rule.

An apparatus for wireless communications at a UE is described. The apparatus may include a processor, memory coupled with the processor, and instructions stored in the memory. The instructions may be executable by the processor to cause the apparatus to identify that the UE is to participate in a random access procedure with a base station, where the random access procedure is for establishing a connection with the base station for a set of logical channels that have different quality of service levels, receive, from the base station, a configuration message identifying a random access rule for prioritizing, during the random access procedure, a higher priority logical channel of the set of logical channels, where the higher priority logical channel has a higher quality of service level than others of the set of logical channels, select, for establishing the connection with the base station, a two-step random access procedure, a four-step random access procedure, or both, based on the random access rule, and establish the connection with the base station for the higher priority logical channel in accordance with the random access rule.

Another apparatus for wireless communications at a UE is described. The apparatus may include means for identifying that the UE is to participate in a random access procedure with a base station, where the random access procedure is for establishing a connection with the base station for a set of logical channels that have different quality of service levels, receiving, from the base station, a configuration message identifying a random access rule for prioritizing, during the random access procedure, a higher priority logical channel of the set of logical channels, where the higher priority logical channel has a higher quality of service level than others of the set of logical channels, selecting, for establishing the connection with the base station, a two-step random access procedure, a four-step random access procedure, or both, based on the random access rule, and establishing the connection with the base station for the higher priority logical channel in accordance with the random access rule.

A non-transitory computer-readable medium storing code for wireless communications at a UE is described. The code may include instructions executable by a processor to identify that the UE is to participate in a random access procedure with a base station, where the random access procedure is for establishing a connection with the base station for a set of logical channels that have different quality of service levels, receive, from the base station, a configuration message identifying a random access rule for prioritizing, during the random access procedure, a higher priority logical channel of the set of logical channels, where the higher priority logical channel has a higher quality of service level than others of the set of logical channels, select, for establishing the connection with the base station, a two-step random access procedure, a four-step random access procedure, or both, based on the random access rule, and establish the connection with the base station for the higher priority logical channel in accordance with the random access rule.

In some examples of the method, apparatuses, and non-transitory computer-readable medium described herein, selecting, for establishing the connection with the base station, the two-step random access procedure, the four-step random access procedure, or both, may include operations, features, means, or instructions for determining to use both the two-step random access procedure and the four-step random access procedure for the higher priority logical channel based on the random access rule.

In some examples of the method, apparatuses, and non-transitory computer-readable medium described herein, selecting, for establishing the connection with the base station, the two-step random access procedure, the four-step random access procedure, or both, may include operations, features, means, or instructions for determining, an availability, a contention probability, or both associated with both the two-step random access procedure and the four-step random access procedure based on the random access rule, and determining, based on the random access rule, to use either the two-step random access procedure or the four-step random access procedure based on the determined availability or the contention probability associated with the two-step random access procedure and the four-step random access procedure.

In some examples of the method, apparatuses, and non-transitory computer-readable medium described herein, selecting, for establishing the connection with the base station, the two-step random access procedure, the four-step random access procedure, or both, may include operations, features, means, or instructions for identifying, based on the random access rule, a link quality associated with each of a set of carrier bandwidths supported by the UE, selecting one of the set of carrier bandwidths based on the link quality for the higher priority logical channel, and determining, based on whether the selected one of the set of carrier bandwidths may be associated with the two-step random access procedure or the four-step random access procedure, to use either the two-step random access procedure or the four-step random access procedure.

A method of wireless communications at a base station is described. The method may include transmitting, to a UE, a configuration message identifying one or more reference signals to be measured by the UE in determining a link quality for communications between the UE and the base station, where the configuration message also includes an identification of one or more link quality thresholds corresponding to the one or more reference signals and establishing a connection with the UE via a two-step random access procedure, a four-step random access procedure, or both based on whether the link quality satisfies the at least one of the one or more link quality thresholds.

An apparatus for wireless communications at a base station is described. The apparatus may include a processor, memory coupled with the processor, and instructions stored in the memory. The instructions may be executable by the processor to cause the apparatus to transmit, to a UE, a configuration message identifying one or more reference signals to be measured by the UE in determining a link quality for communications between the UE and the base station, where the configuration message also includes an identification of one or more link quality thresholds corresponding to the one or more reference signals and establish a connection with the UE via a two-step random access procedure, a four-step random access procedure, or both based on whether the link quality satisfies the at least one of the one or more link quality thresholds.

Another apparatus for wireless communications at a base station is described. The apparatus may include means for transmitting, to a UE, a configuration message identifying one or more reference signals to be measured by the UE in determining a link quality for communications between the UE and the base station, where the configuration message also includes an identification of one or more link quality thresholds corresponding to the one or more reference signals and establishing a connection with the UE via a two-step random access procedure, a four-step random access procedure, or both based on whether the link quality satisfies the at least one of the one or more link quality thresholds.

A non-transitory computer-readable medium storing code for wireless communications at a base station is described. The code may include instructions executable by a processor to transmit, to a UE, a configuration message identifying one or more reference signals to be measured by the UE in determining a link quality for communications between the UE and the base station, where the configuration message also includes an identification of one or more link quality thresholds corresponding to the one or more reference signals and establish a connection with the UE via a two-step random access procedure, a four-step random access procedure, or both based on whether the link quality satisfies the at least one of the one or more link quality thresholds.

Some examples of the method, apparatuses, and non-transitory computer-readable medium described herein may further include operations, features, means, or instructions for transmitting, to the UE, the configuration message identifying one or more transmission parameters for inclusion in a first message of the two-step random access procedure.

In some examples of the method, apparatuses, and non-transitory computer-readable medium described herein, the one or more transmission parameters include a modulation coding scheme, a waveform, a bandwidth, a payload size, a numerology, or a combination thereof.

Some examples of the method, apparatuses, and non-transitory computer-readable medium described herein may further include operations, features, means, or instructions for transmitting, to the base station, an indication of system loading information.

In some examples of the method, apparatuses, and non-transitory computer-readable medium described herein, transmitting the indication of system loading information may include operations, features, means, or instructions for transmitting the indication as an increase or a decrease of the one or more link quality thresholds.

In some examples of the method, apparatuses, and non-transitory computer-readable medium described herein, transmitting the indication of system loading information may include operations, features, means, or instructions for transmitting the indication of system loading information via radio resource control signaling.

In some examples of the method, apparatuses, and non-transitory computer-readable medium described herein, transmitting the configuration message identifying one or more reference signals to be measured by the UE may include operations, features, means, or instructions for transmitting the configuration message via radio resource control signaling.

Some examples of the method, apparatuses, and non-transitory computer-readable medium described herein may further include operations, features, means, or instructions for transmitting a second configuration message updating the one or more link quality thresholds corresponding to the one or more reference signals, where the connection may be established with the UE based on whether the link quality satisfies at least one of the one or more updated link quality thresholds.

Some examples of the method, apparatuses, and non-transitory computer-readable medium described herein may further include operations, features, means, or instructions for transmitting a second configuration message indicating a selection of the four-step random access procedure, where the connection may be established with the UE using the four-step random access procedure.

In some examples of the method, apparatuses, and non-transitory computer-readable medium described herein, the one or more reference signals to be measured include a synchronization signal block, a channel state information reference signal, a positioning reference signal, a system information block, or a combination thereof.

A method of wireless communications at a base station is described. The method may include transmitting, to a UE, a configuration message identifying a random access rule for prioritizing, during a random access procedure, a higher priority logical channel of a set of logical channels, where the higher priority logical channel has a higher quality of service level than others of the set of logical channels and establishing a connection with the UE for the higher priority logical channel in accordance with the random access rule.

An apparatus for wireless communications at a base station is described. The apparatus may include a processor, memory coupled with the processor, and instructions stored in the memory. The instructions may be executable by the processor to cause the apparatus to transmit, to a UE, a configuration message identifying a random access rule for prioritizing, during a random access procedure, a higher priority logical channel of a set of logical channels, where the higher priority logical channel has a higher quality of service level than others of the set of logical channels and establish a connection with the UE for the higher priority logical channel in accordance with the random access rule.

Another apparatus for wireless communications at a base station is described. The apparatus may include means for transmitting, to a UE, a configuration message identifying a random access rule for prioritizing, during a random access procedure, a higher priority logical channel of a set of logical channels, where the higher priority logical channel has a higher quality of service level than others of the set of logical channels and establishing a connection with the UE for the higher priority logical channel in accordance with the random access rule.

A non-transitory computer-readable medium storing code for wireless communications at a base station is described. The code may include instructions executable by a processor to transmit, to a UE, a configuration message identifying a random access rule for prioritizing, during a random access procedure, a higher priority logical channel of a set of logical channels, where the higher priority logical channel has a higher quality of service level than others of the set of logical channels and establish a connection with the UE for the higher priority logical channel in accordance with the random access rule.

In some examples of the method, apparatuses, and non-transitory computer-readable medium described herein, the random access rule indicates establishment of the connection with the UE for the higher priority logical channel using both a two-step random access procedure and a four-step random access procedure.

In some examples of the method, apparatuses, and non-transitory computer-readable medium described herein, the random access rule indicates establishment of the connection with the UE for the higher priority logical channel using either a two-step random access procedure or a four-step random access procedure based on an availability, a contention probability, or both associated with both the two-step random access procedure and the four-step random access procedure based on the random access rule.

In some examples of the method, apparatuses, and non-transitory computer-readable medium described herein, the random access rule indicates establishment of the connection with the UE for the higher priority logical channel using either a two-step random access procedure or a four-step random access procedure based on a link quality associated with each of a set of carrier bandwidths supported by the UE.

### BRIEF DESCRIPTION OF THE DRAWINGS

FIG. 1 illustrates an example of a system for wireless communications that supports procedures and signaling support for random access channel (RACH) type selection in accordance with aspects of the present disclosure.

FIG. 2 illustrates an example of a wireless communications system that supports procedures and signaling support for RACH type selection in accordance with aspects of the present disclosure.

FIG. 3 illustrates an example of a process flow diagram that supports procedures and signaling support for RACH type selection in accordance with aspects of the present disclosure.

FIG. 4 illustrates an example of a process flow diagram that supports procedures and signaling support for RACH type selection in accordance with aspects of the present disclosure.

FIGS. 5 and 6 show block diagrams of devices that support procedures and signaling support for RACH type selection in accordance with aspects of the present disclosure.

FIG. 7 shows a block diagram of a communications manager that supports procedures and signaling support for RACH type selection in accordance with aspects of the present disclosure.

FIG. 8 shows a diagram of a system including a device that supports procedures and signaling support for RACH type selection in accordance with aspects of the present disclosure.

FIGS. 9 and 10 show block diagrams of devices that support procedures and signaling support for RACH type selection in accordance with aspects of the present disclosure.

FIG. 11 shows a block diagram of a communications manager that supports procedures and signaling support for RACH type selection in accordance with aspects of the present disclosure.

FIG. 12 shows a diagram of a system including a device that supports procedures and signaling support for RACH type selection in accordance with aspects of the present disclosure.

FIGS. 13 through 19 show flowcharts illustrating methods that support procedures and signaling support for RACH type selection in accordance with aspects of the present disclosure.

### DETAILED DESCRIPTION

Certain wireless communications radio access technologies may support different random access channel (RACH) procedures for establishing connections between a user equipment (UE) and a base station. In some cases, a radio access technologies support a two-step RACH procedure and a four-step RACH procedure. Utilization of one procedure over the other may incur tradeoffs. For example, the two-step RACH may support non-orthogonal multiple access (NOMA) transmission of demodulation reference signals/physical uplink share channels, which may be beneficial in RACH capacity enhancement, signaling overhead, and latency reduction. However, performance of two-step RACH may be degraded due to link quality deterioration due to fading, blocking, and/or mobility, increase of UE overloading ratio (e.g., a relatively high number of UEs in a cell), traffic pre-emption, limitation of UE capabilities, limitation of base station implementation, and/or imperfect power timing control. In such cases, a four-step RACH procedure may be more reliable and efficient for establishing a connection with a base station.

The techniques described herein support RACH type selection by a UE to leverage the performance gains of both the two-step RACH and four-step RACH procedures. The UE may utilize the described techniques to select between the two-step RACH procedure and the four-step RACH procedure at the beginning of a random access procedure. The selection techniques may be applicable to numerous cell sizes, various operating bands, and licensed as well as unlicensed spectrum. In some cases, a base station may configure a UE to select a RACH type based on a link quality threshold. In such cases, the base station may identify one or more reference signals and link quality thresholds to consider in selecting a RACH type. The base station may also provide the UE with transmission parameters for a first message in the two-step RACH procedure. Based on the UE's capability to support the transmission parameters, the UE may select either the two-step RACH procedure or the four-step RACH procedure. In some examples, the base station may provide an indication of system loading information (e.g., traffic patterns in a cell). Based on the system loading information and the link quality measurements, the UE may select either the two-step RACH or four-step RACH procedure.

The techniques described herein further support a UE participating in a random access procedure for establishing a connection with the base station for a plurality of logical channels that have different quality of service levels. The base station may transmit a configuration message to the UE, and the configuration message may indicate a random access rule for prioritizing, during the random access procedure, a higher priority logical channel of the plurality of logical channels. Based on the indicated random access rule, the UE may select a two-step random access procedure, a four-step random access procedure, or both to establish the connection with the base station.

Particular aspects of the subject matter described herein may be implemented to realize one or more advantages. The described techniques may support improvements in the random access framework, decreasing signaling overhead, and improving reliability, among other advantages. As such, supported techniques may include improved network operations and, in some examples, may promote network efficiencies, among other benefits. Aspects of the disclosure are initially described in the context of a wireless communications system. Aspects of the disclosure are further described with a communications system illustrating selection of a RACH type and process flow diagrams illustrating selection of a RACH type. Aspects of the disclosure are further illustrated by and described with reference to apparatus diagrams, system diagrams, and flowcharts that relate to procedures and signaling support for RACH type selection.

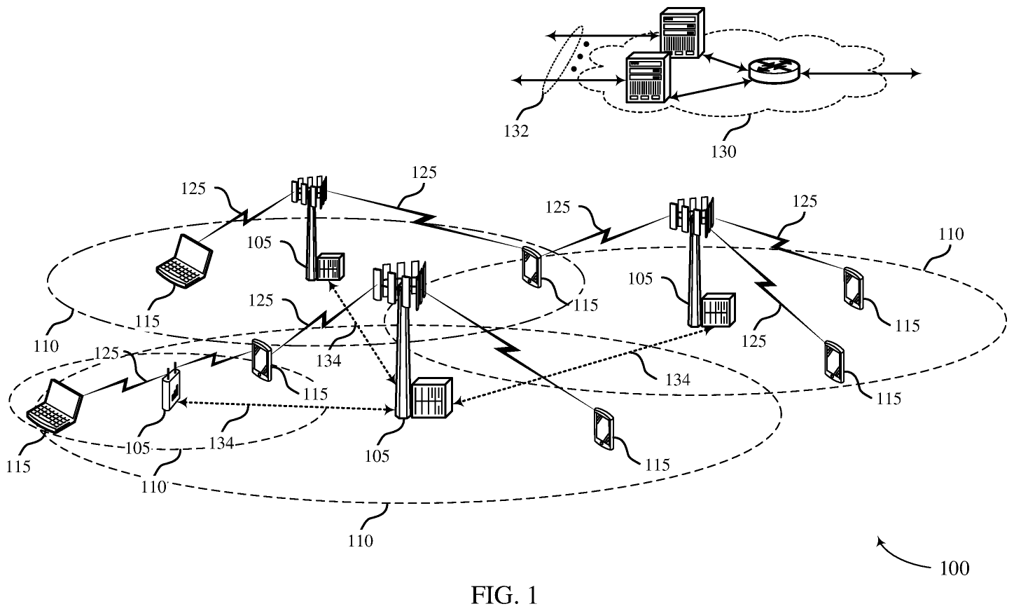

FIG. 1 illustrates an example of a wireless communications system 100 that supports procedures and signaling support for RACH type selection in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples, a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ= 1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

A UE 115 may implement one or more random access (e.g., RACH) procedures to establish a communication link 125 with a base station 105. In some cases, the wireless communications system 100 and various UEs 115 may support a two-step random access procedure and a four-step random access procedures. Implementations described herein provide techniques for a UE 115 to leverage the performance gains of both the two-step RACH and four-step RACH procedures. The UE 115 may utilize the described techniques to select between the two-step RACH procedure and the four-step RACH procedure at the beginning of a random access procedure. The selection techniques may be applicable to numerous cell sizes, various operating bands, and licensed as well as unlicensed spectrum. In some cases, a base station 105 may configure a UE 115 to select a RACH type based on a link quality threshold. In such cases, the base station may identify one or more reference signals and link quality thresholds to consider in selecting a RACH type. The base station 105 may also provide the UE 115 with transmission parameters for a first message in the two-step RACH procedure. Based on the UE's 115 capability to support the transmission parameters, the UE 115 may select either the two-step RACH procedure or the four-step RACH procedure. In some examples, the base station 105 may provide an indication of system loading information (e.g., traffic patterns in a cell). Based on the system loading information and the link quality measurements, the UE 115 may select either the two-step RACH or four-step RACH procedure.

The techniques described herein further support a UE 115 participating in a random access procedure for establishing a connection with the base station 105 for a plurality of logical channels that have different quality of service levels. The base station 105 may transmit a configuration message to the UE 115, and the configuration message may indicate a random access rule for prioritizing, during the random access procedure, a higher priority logical channel of the plurality of logical channels. Based on the indicated random access rule, the UE 115 may select a two-step random access procedure, a four-step random access procedure, or both to establish the connection with the base station.

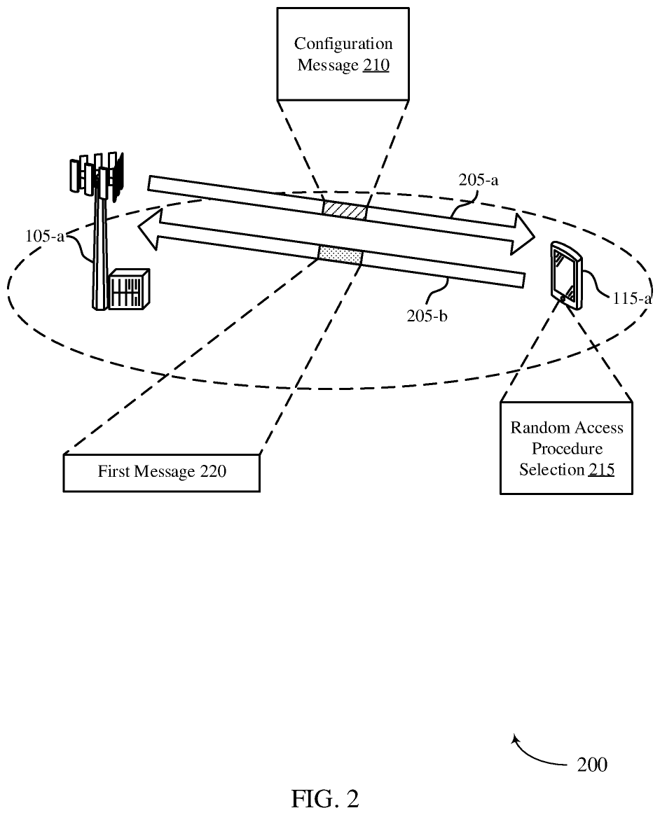

FIG. 2 illustrates an example of a wireless communications system 200 that supports procedures and signaling support for RACH type selection in accordance with various aspects of the present disclosure. In some examples, wireless communications system 200 may implement aspects of wireless communications system 100. Wireless communications system 200 may include a base station 105-a and a UE 115-a, which may be examples of corresponding base stations 105 and UEs 115, respectively, as described herein with reference to FIG. 1. In some cases, UE 115-a may perform a RACH procedure to connect with base station 105-a as part of an initial cell selection, a cell reselection, or a similar access procedure. Accordingly, base station 105-a may transmit downlink messages to UE 115-a on resources of a carrier 205-a, and UE 115-a may transmit uplink messages to base station 105-a on resources of a carrier 205-b. In some cases, carriers 205-a and 205-b may be a same carrier or may be separate carriers. For example, base station 105-a may broadcast the downlink messages on time and frequency resources reserved for broadcasted transmissions, which may be different than resources allocated for uplink messages from UE 115-a or other UEs 115 in the coverage area of base station 105-a. Additionally or alternatively, UE 115-a may be in a connected state (e.g., RRC_CONNECTED state) with base station 105-a, and downlink messages and uplink messages may be transmitted on a same carrier established previously.

As described herein, UE 115-a may perform a two-step RACH procedure or a four-step RACH procedure to establish a connection with base station 105-a (e.g., initial connection, reestablishment, etc.). Accordingly, base station 105-a may transmit a configuration message 210 to identify configurations to utilize in determining whether to utilize the two-step RACH procedure or the four-step RACH procedure. The configuration message 210 may identify one or more reference signal resources for link quality measurements. In some cases, the link quality measurements may include reference signal received power (RSRP) measurements based on a synchronization signal blocks (SSBs), a channel state information reference signal (CSI-RS), positioning reference signal (PRS), system information block (SIB), or a combination thereof. The configuration message 210 may indicate link quality measurement configuration for RACH type selection in broadcast system information (SI) or in RRC signaling. The configuration message 210 may also indicate one or more thresholds for comparing the measurements in selecting either the two-step RACH procedure or the four-step RACH procedure in a random access procedure selection 215. For example, if a measurement (e.g., RSRP) is greater than the indicated threshold, then the UE may select the two-step RACH procedure for establishing the connection. In contrast, if the measurement is less than the indicated threshold, then the UE may select the four-step RACH procedure for establishing the connection. Depending on the selected RACH procedure, the UE 115-a may transmit a first message 220 to the base station 105-a to initiate the RACH procedure. In a two-step RACH procedure, the first message 220 may be MsgA, and in a four-step RACH procedure, the first message 220 may be Msg1.

In some cases, the configuration information (e.g., reference signal identifiers and thresholds) may be cell-specific and updated periodically. For example, based on UE congestion level in a specific cell, the base station 105-a may increase a threshold for link quality and RACH procedure selection using another configuration message 210. In other cases, the threshold may increase with a respective increase in distance between a UE 115-a and a base station 105-a. In some implementations when both two-step RACH and four-step RACH are enabled, a base station 105-a may indicate (e.g., via configuration message 210) to the UE 115-a to utilize a four-step RACH procedure. In other words, the base station 105-a may bar the UE 115-a from using resources for the two-step RACH procedure.

In addition to using link quality measurements for RACH procedure selection, techniques may support RACH type selection based on UE 115-a capabilities. A first message (e.g., msgA) in the two-step RACH procedure may include transmission parameters such as modulation coding scheme (MCS), waveform configuration, bandwidth, payload size, numerology, etc. In some cases, these parameters may cell-specific and indicated in the configuration message 210 transmitted by the base station 105-a to the UE 115-a. If the UE 115-a can support the indicated transmission parameters, the UE 115-a may select the two-step RACH procedure for establishing the connection. In some cases, the ability to support the transmission parameters may depend on the link quality measurements. As such, the UE 115-a may consider the link quality measurements and the indicated transmission parameters to select either the two-step RACH procedure or the four-step RACH procedure. Further, based on the UE 115-a capabilities (with respect to the transmission parameters), such as transmission power limit, bandwidth constraints, limitations on MCS or waveform support, buffer size, and UE 115-a status, the UE may select between the two-step RACH procedure or the four-step RACH procedure. In one example, if the network (e.g., base station 105-a) has configured pi/2 binary phase shift keying (BPSK) in two-step RACH for large pathloss scenarios, but UE 115-a is not able to support pi/2 BPSK or DFT-s-OFDM, then the UE 115-a may select four-step RACH when the associated pathloss increases.

In some cases, the UE 115-a may randomly select a RACH procedure. For example, the UE 115-a may determine that it may support both the two-step RACH (e.g., based on the transmission parameters indicated in the configuration message 210) and the four-step RACH. If the UE 115-a is scheduled to transmit a relatively large payload size, then the UE may either use four-step RACH and request resource grants for large transmission block size (TBS), or the UE 115-a may use packet segmentation together with two-step RACH supporting smaller TBS.

The techniques may further support RACH type selection based on system loading. A traffic pattern in a cell can vary within time, and the traffic pattern may correspond to packet arrival rate at UEs 115, payload size distribution, traffic pre-emption for URLLC, etc. Further, the resource (e.g., time, frequency, code) configuration for two-step RACH may be semi-static. For example, random access occasion sharing between two-step RACH and four-step RACH, physical uplink shared channel (PUSCH) resource unit specification, slot format configuration, and dynamic TDD, may vary with time and traffic patterns within a cell. As such, the network (e.g., base station 105-a) may broadcast the variation of system loading using RRC or other physical channels/signals. In some cases, the base station 105-a may signal the variation in system loading by increasing or decreasing the threshold for determining link quality using configuration message 210. Accordingly, the UE 115-a may consider system loading information, in conjunction with the link quality measurements, in selecting the two-step RACH procedure or the four-step RACH procedure. In one example, if a UE overloading ratio on resource configured for two-step RACH is beyond a threshold (e.g., beyond a NOMA capacity) of a two-step RACH, then the UE 115-a may select the four-step RACH. Otherwise, the UE 115-a may select the two-step RACH.

The techniques also support RACH type selection based on quality of service (QoS). When UE 115-a is establishing a connection with the base station 105-a for a plurality of logical channels that have different priority levels. The UE 115-a may prioritize the logical channel (e.g., packet) with higher quality of service requirements. This process may be utilized in addition to link quality determinations, or the process may be utilized without consideration of the link qualities and link quality thresholds. A base station 105 may transmit a configuration message 210 identifying a random access rule for prioritizing channels during a random access procedure. Each channel may be associated with a quality of service, and one channel may have a higher quality of service association than other channels. Based on the random access rule received from the base station 105-a, the UE 115-a may transmit a higher quality of service logical channel using both the two-step RACH and the four-step RACH, which may improve reliability for the higher quality of service channel. The random access rule may also indicate that the UE 115-a transmit a higher quality of service channel using a RACH type with higher availability and lower contention probability. As such, the UE 115-a may consider cell traffic patterns, in conjunction with quality of service associations, when selecting a RACH type.

In some cases, the random access rule indicates (e.g., via the configuration message 210), for a UE 115 with carrier aggregation or dual connectivity capability, that the UE 115 prioritize the higher quality of service channel on a carrier with better link quality and/or more RACH resources. Accordingly, if a two-step RACH is associated with the carrier with better link quality and/or more RACH resources, then the UE 115-a may select the two-step RACH. Similarly, if the four-step RACH is associated with the carrier with better link quality and/or more RACH resources, then the UE 115-a may select the four-step RACH. In some cases, the prioritization of carriers may be combined with power control, which may configure higher transmission power for the higher quality of service packet. It should be understood that other types of random access rules for consideration of quality of service in RACH type selection are considered.

One or more potential benefits may be provided by the RACH selection described herein. For example, using the techniques described, the UE 115 may identify the efficient two-step random access process when the cell conditions are appropriate (e.g., not degraded). Accordingly, when the link quality is above a threshold, the UE 115 may utilize the high capacity resources associated with the two-step RACH procedure. However, when signal resources (e.g., link qualities) are degraded due to various circumstances (e.g., fading, blocking, mobility, UE overloading), then the UE may select the four-step RACH procedure for connection establishment reliability. Further, the UE may select one or more of the RACH procedures based on quality of service associated with one or more channels to increase reliability.

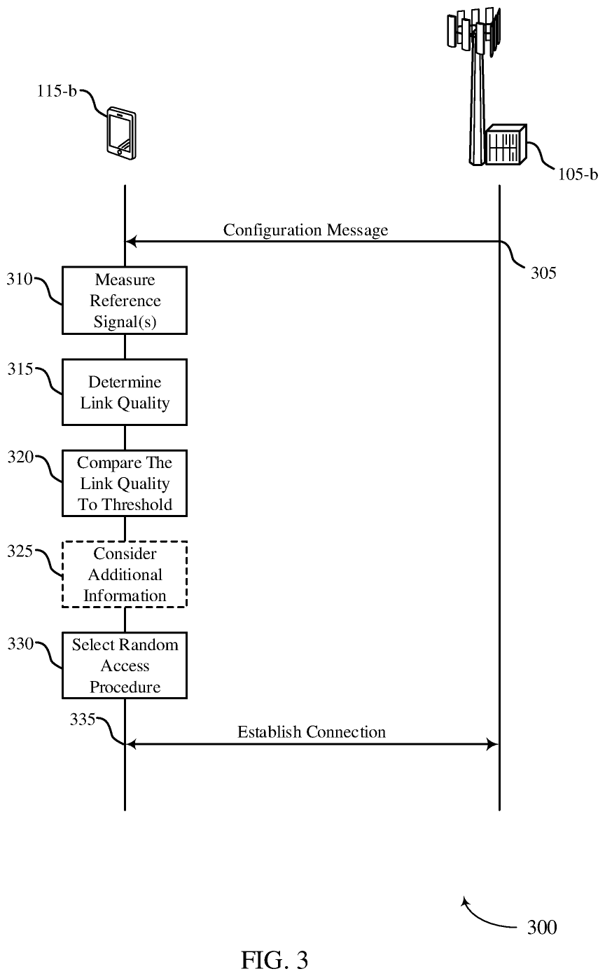

FIG. 3 illustrates an example of a process flow 300 that supports procedures and signaling support for RACH type selection in accordance with various aspects of the present disclosure. In some examples, process flow 300 may implement aspects of wireless communications systems 100 and/or 200. Process flow 300 may include a base station 105-b and a UE 115-b, which may be examples of corresponding base stations 105 and UEs 115, respectively, as described herein with reference to FIGS. 1-2.

At 305, the base station 105-b transmits a configuration message to the UE 115-b. The configuration message may be transmitted via RRC signaling. The configuration message may identify one or more reference signals to be measured by the UE in determining a link quality for communications between the UE and the base station. The identified reference signals may be reference signal resources such as a synchronization signal block, a channel state information reference signal, a positioning reference signal, a system information block, or a combination thereof. The configuration message may further include an identification of one or more link quality thresholds corresponding to the identified reference signals. In some cases, the configuration message identifies one or more transmission parameters for inclusion in a first message of a two-step random access procedure. In some cases, the configuration message may also include an indication of system loading information. In examples, the configuration message may include a random access rule for random access procedure selection.

At 310, the UE 115-b measures the identified reference signal. In some cases, the measurement includes a RSRP. At 315, the UE 115-b determines the link quality for communications between the UE 115-b and the base station 105-b based at least in part on the measurements made of the one or more reference signals.

At 320, the UE 115-b compares the link quality to the one or more thresholds identified in the configuration message. At 325, the UE 115-b considers additional information, such as transmission parameters, system loading information, random access rules, or quality of service associated with one or more channels. In some cases, the additional information is received in the configuration message at 305. At 330, the UE 115-b selects, for establishing a connection with a base station, the two-step random access procedure, the four-step random access procedure, or both based at least in part on whether the link quality satisfies the one or more link quality thresholds. In some cases, the selection is based further on whether the UE 115-b supports one or more transmission parameters received in the configuration message. In some examples, the UE 115-b considers system loading information indicated by the configuration message and/or one or more random access rules indicated by the configuration message in selecting the random access procedure.

At 335, the UE 115-b establishes a connection with the base station 105-b using the selected random access procedure. The procedure may be initiated by the UE sending a message (e.g., MsgA or Msg1) corresponding to the selected procedure.

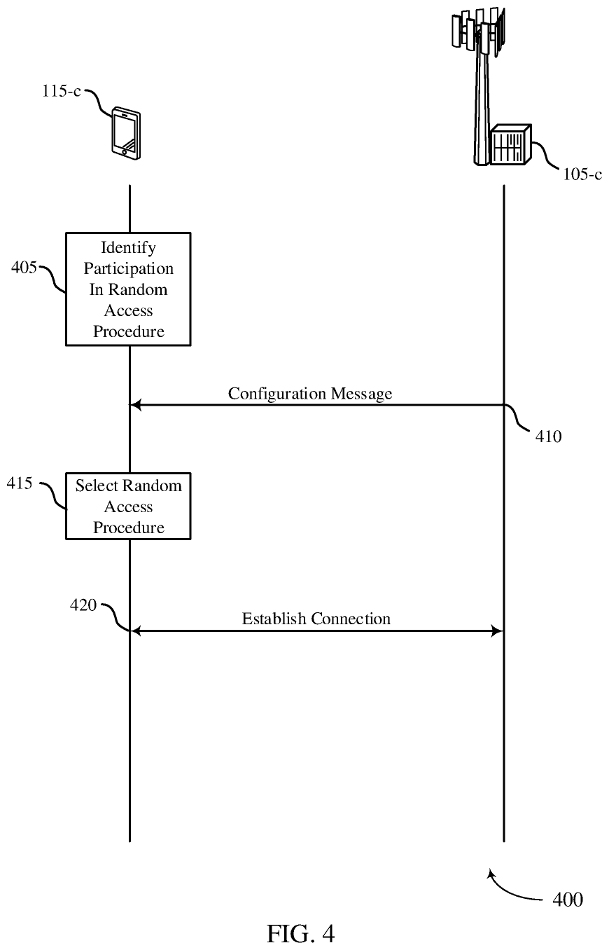

FIG. 4 illustrates an example of a process flow 400 that supports procedures and signaling support for RACH type selection in accordance with various aspects of the present disclosure. In some examples, process flow 400 may implement aspects of wireless communications systems 100 and/or 200. Process flow 400 may include a base station 105-c and a UE 115-c, which may be examples of corresponding base stations 105 and UEs 115, respectively, as described herein with reference to FIGS. 1-3.

At 405, UE 115-c identifies that the UE 115-c is to participate in a random access procedure with a base station. The random access procedure is for establishing a connection with the base station for a plurality of logical channels that have different quality of service levels.

At 410, the base station 105-c transmits a configuration message to the UE 115-c. The configuration message may identify a random access rule for prioritizing, during a random procedure, a higher priority logical channel of the plurality of logical channels. The higher priority logical channel may have a higher quality of service level than others of the plurality of logical channels.

At 415, the UE 115-c selects, for establishing the connection with the base station, a two-step random access procedure, a four-step random access procedure, or both, based at least in part on the random access rule. In some cases, the UE 115-c determines to use both the two-step random access procedure and the four-step random access procedure for the higher priority logical channel based on the random access rule. In some cases, the UE 115-c determines, an availability, a contention probability, or both associated with both the two-step random access procedure and the four-step random access procedure based on the random access rule, and selects the random access procedure based on the availability or contention probability. In some examples, the UE 115-c considers a link quality associated with each of a plurality of carrier bandwidths based on the random access rule. The UE 115-c may then select one of the bandwidths based on the link quality and select the RACH procedure (e.g., two-step or four-step) based on the procedure associated with the selected carrier bandwidth. At 420, the UE 115-c establishes the connection with the base station 105-c in accordance with the random access rule.

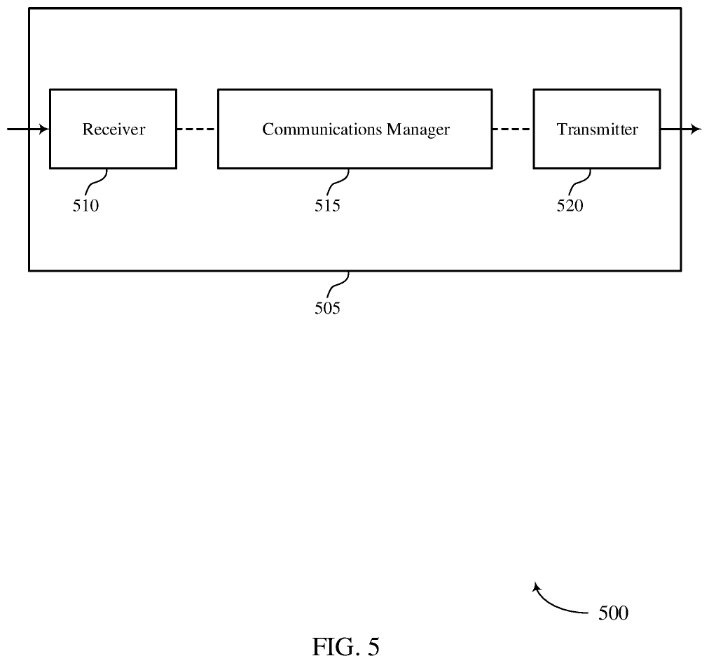

FIG. 5 shows a block diagram 500 of a device 505 that supports procedures and signaling support for RACH type selection in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

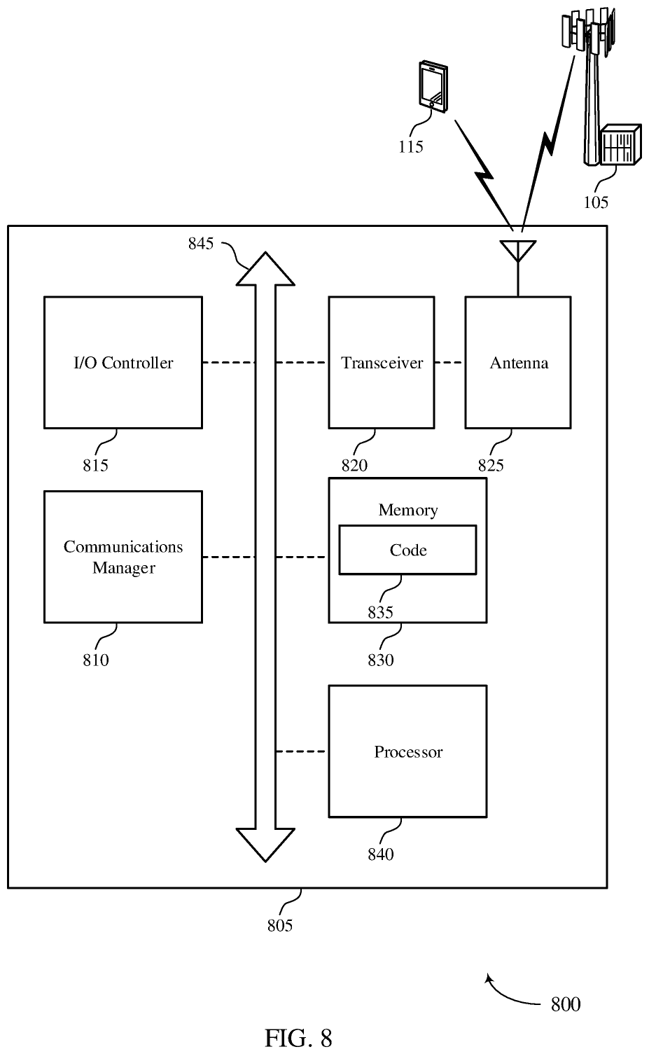

The receiver 510 may receive information such as packets, user data, or control information associated with various information channels (e.g., control channels, data channels, and information related to procedures and signaling support for RACH type selection, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a base station, a configuration message identifying one or more reference signals to be measured by the UE in determining a link quality for communications between the UE and the base station, where the configuration message also includes an identification of one or more link quality thresholds corresponding to the one or more reference signals, determine the link quality for communications between the UE and the base station based on measurements made of at least one of the one or more reference signals, compare the link quality to a corresponding at least one of the one or more link quality thresholds, and select, for establishing a connection with the base station, a two-step random access procedure, a four-step random access procedure, or both based on whether the link quality satisfies the at least one of the one or more link quality thresholds. The communications manager 515 may also identify that the UE is to participate in a random access procedure with a base station, where the random access procedure is for establishing a connection with the base station for a set of logical channels that have different quality of service levels, receive, from the base station, a configuration message identifying a random access rule for prioritizing, during the random access procedure, a higher priority logical channel of the set of logical channels, where the higher priority logical channel has a higher quality of service level than others of the set of logical channels, select, for establishing the connection with the base station, a two-step random access procedure, a four-step random access procedure, or both, based on the random access rule, and establish a connection with the base station for the higher priority logical channel in accordance with the random access rule. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

One implementation is receiving, from a base station, a configuration message identifying one or more reference signals to be measured by the UE in determining a link quality for communications between the UE and the base station, wherein the configuration message also includes an identification of one or more link quality thresholds corresponding to the one or more reference signals, determining the link quality for communications between the UE and the base station based at least in part on measurements made of at least one of the one or more reference signals, comparing the link quality to a corresponding at least one of the one or more link quality thresholds, and selecting, for establishing a connection with the base station, a two-step random access procedure, a four-step random access procedure, or both based at least in part on whether the link quality satisfies the at least one of the one or more link quality thresholds. This implementation may be used to select the high reliability or efficiency random access procedure depending on link quality in cell. Accordingly, the UE may select the appropriate RACH procedure based on the signal conditions in the cell, which may increase communication reliability, latency, etc. with a base station.

The actions performed by the communications manager 515 as described herein may be implemented to realize one or more potential advantages. One implementation may allow a UE 115 to save power and increase battery life by avoiding using a random access procedure for establishing a connection when the link quality is not appropriate for the selected random access procedure. Rather, the battery life may be saved by using a random access procedure for efficient connection establishment based on the link quality in a cell.

Based on selecting a random access procedure based on a link quality, a processor of a UE 115 may efficiently establish a connection with a base station. The processor of the UE 115 may turn on one or more processing units for establishing the connection, increase a processing clock, or similar mechanism within the UE 115. As such, when the UE 115 is ready to establish the connection, the processor may be ready to respond efficiently through the reduction of ramp-up in processing power. Further, a processor of UE 115 may not waste processing resources on using a random access procedure that may be inappropriate for the link quality.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

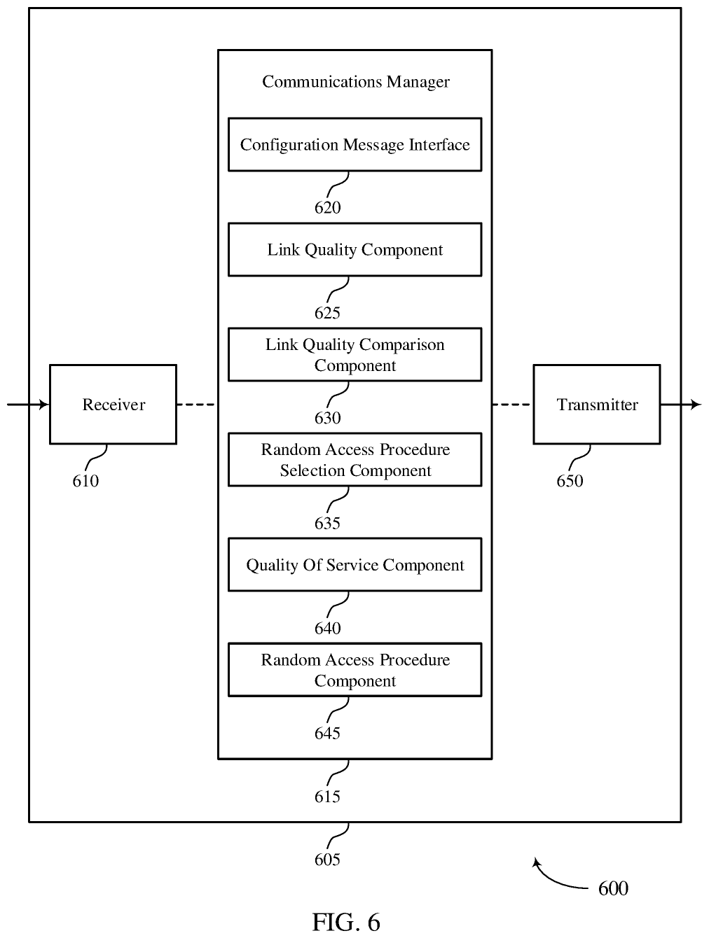

FIG. 6 shows a block diagram 600 of a device 605 that supports procedures and signaling support for RACH type selection in accordance with aspects of the present disclosure. The device 605 may be an example of aspects of a device 505, or a UE 115 as described herein. The device 605 may include a receiver 610, a communications manager 615, and a transmitter 650. The device 605 may also include a processor. Each of these components may be in communication with one another (e.g., via one or more buses).

The receiver 610 may receive information such as packets, user data, or control information associated with various information channels (e.g., control channels, data channels, and information related to procedures and signaling support for RACH type selection, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a configuration message interface 620, a link quality component 625, a link quality comparison component 630, a random access procedure selection component 635, a quality of service component 640, and a random access procedure component 645. The communications manager 615 may be an example of aspects of the communications manager 810 described herein.

The configuration message interface 620 may receive, from a base station, a configuration message identifying one or more reference signals to be measured by the UE in determining a link quality for communications between the UE and the base station, where the configuration message also includes an identification of one or more link quality thresholds corresponding to the one or more reference signals. The link quality component 625 may determine the link quality for communications between the UE and the base station based on measurements made of at least one of the one or more reference signals. The link quality comparison component 630 may compare the link quality to a corresponding at least one of the one or more link quality thresholds.

The random access procedure selection component 635 may select, for establishing a connection with the base station, a two-step random access procedure, a four-step random access procedure, or both based on whether the link quality satisfies the at least one of the one or more link quality thresholds.

The quality of service component 640 may identify that the UE is to participate in a random access procedure with a base station, where the random access procedure is for establishing a connection with the base station for a set of logical channels that have different quality of service levels.

The configuration message interface 620 may receive, from the base station, a configuration message identifying a random access rule for prioritizing, during the random access procedure, a higher priority logical channel of the set of logical channels, where the higher priority logical channel has a higher quality of service level than others of the set of logical channels.

The random access procedure selection component 635 may select, for establishing the connection with the base station, a two-step random access procedure, a four-step random access procedure, or both, based on the random access rule. The random access procedure component 645 may establish a connection with the base station for the higher priority logical channel in accordance with the random access rule.

The transmitter 650 may transmit signals generated by other components of the device 605. In some examples, the transmitter 650 may be collocated with a receiver 610 in a transceiver module. For example, the transmitter 650 may be an example of aspects of the transceiver 820 described with reference to FIG. 8. The transmitter 650 may utilize a single antenna or a set of antennas.

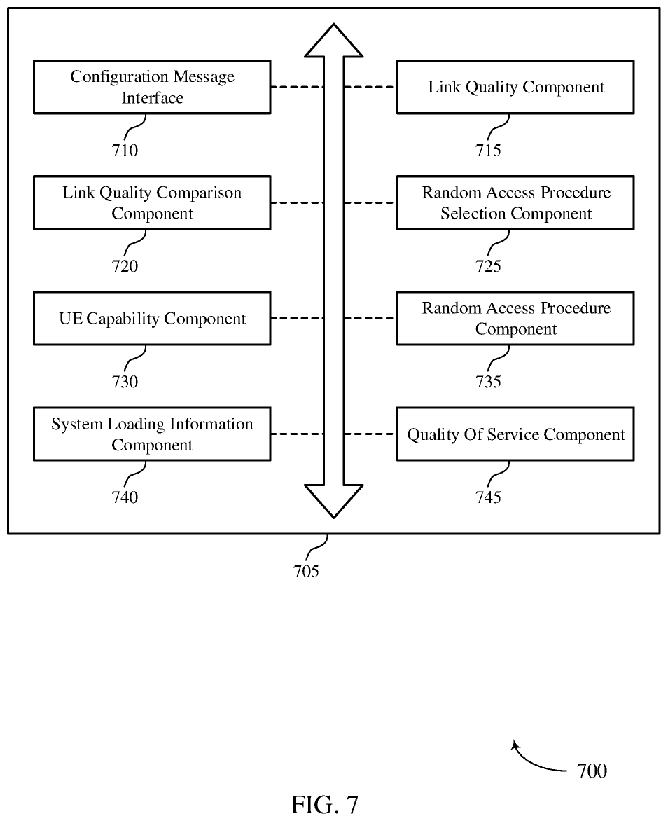

FIG. 7 shows a block diagram 700 of a communications manager 705 that supports procedures and signaling support for RACH type selection in accordance with aspects of the present disclosure. The communications manager 705 may be an example of aspects of a communications manager 515, a communications manager 615, or a communications manager 810 described herein. The communications manager 705 may include a configuration message interface 710, a link quality component 715, a link quality comparison component 720, a random access procedure selection component 725, a UE capability component 730, a random access procedure component 735, a system loading information component 740, and a quality of service component 745. Each of these modules may communicate, directly or indirectly, with one another (e.g., via one or more buses).

The configuration message interface 710 may receive, from a base station, a configuration message identifying one or more reference signals to be measured by the UE in determining a link quality for communications between the UE and the base station, where the configuration message also includes an identification of one or more link quality thresholds corresponding to the one or more reference signals.

In some examples, the configuration message interface 710 may receive, from the base station, a configuration message identifying a random access rule for prioritizing, during the random access procedure, a higher priority logical channel of the set of logical channels, where the higher priority logical channel has a higher quality of service level than others of the set of logical channels.

In some examples, the configuration message interface 710 may receive, from the base station, the configuration message identifying one or more transmission parameters for inclusion in a first message of the two-step random access procedure, where the selection of the two-step random access procedure, the four-step random access procedure, or both is further based on determining whether the UE supports the one or more transmission parameters identified by the configuration message. In some examples, the configuration message interface 710 may receive the configuration message via radio resource control signaling.

In some examples, the configuration message interface 710 may receive, from the base station, a second configuration message updating the one or more link quality thresholds corresponding to the one or more reference signals, where the selection of the two-step random access procedure, the four-step random access procedure, or both is based on whether the link quality satisfies at least one of the one or more updated link quality thresholds. In some examples, the configuration message interface 710 may receive, from the base station, a second configuration message indicating a selection of the four-step random access procedure.

In some cases, the one or more transmission parameters include a modulation coding scheme, a waveform, a bandwidth, a payload size, a numerology, or a combination thereof. In some cases, the one or more reference signals to be measured include a synchronization signal block, a channel state information reference signal, a positioning reference signal, a system information block, or a combination thereof.

The link quality component 715 may determine the link quality for communications between the UE and the base station based on measurements made of at least one of the one or more reference signals. In some examples, the link quality component 715 may identify a link quality associated with each of a set of carrier bandwidths supported by the UE.

In some examples, the link quality component 715 may determine a received signal power measurement of the one or more reference signals. In some examples, the link quality component 715 may identify, based on the random access rule, a link quality associated with each of a set of carrier bandwidths supported by the UE. The link quality comparison component 720 may compare the link quality to a corresponding at least one of the one or more link quality thresholds.

The random access procedure selection component 725 may select, for establishing a connection with the base station, a two-step random access procedure, a four-step random access procedure, or both based on whether the link quality satisfies the at least one of the one or more link quality thresholds. In some examples, the random access procedure selection component 725 may select, for establishing the connection with the base station, a two-step random access procedure, a four-step random access procedure, or both, based on the random access rule.

In some examples, the random access procedure selection component 725 may determine to use both the two-step random access procedure and the four-step random access procedure for the higher priority logical channel based on the random access rule. In some examples, the random access procedure selection component 725 may determine, based on the random access rule, to use either the two-step random access procedure or the four-step random access procedure based on the determined availability or the contention probability associated with the two-step random access procedure and the four-step random access procedure.

In some examples, the random access procedure selection component 725 may determine, based on whether the selected one of the set carrier bandwidths is associated with the two-step random access procedure or the four-step random access procedure, to use either the two-step random access procedure or the four-step random access procedure. The random access procedure component 735 may establish a connection with the base station for the higher priority logical channel in accordance with the random access rule. In some examples, the random access procedure component 735 may establish the connection via the two-step random access procedure based on determining that the UE supports the one or more transmission parameters.

In some examples, the random access procedure component 735 may establish the connection via the four-step random access procedure based on determining that the UE does not support the one or more transmission parameters. In some examples, the random access procedure component 735 may identify that the random access procedure is to be repeated.

In some examples, the random access procedure component 735 may re-establish the connection with the base station via the two-step random access procedure, the four-step random access procedure, or both based on the determined quality of service associated with the logical channel. In some examples, the random access procedure component 735 may re-establish the connection with the base station via both the two-step random access procedure and the four-step random access procedure based on determining that the quality of service associated with the logical channel satisfies a quality of service threshold.

In some examples, the random access procedure component 735 may establish the connection with the base station via the two-step random access procedure, the four-step random access procedure, or both based on the determined availability or the contention probability associated with the two-step random access procedure and the four-step random access procedure. In some examples, the random access procedure component 735 may re-establish the connection with the base station via the two-step random access procedure, the four-step random access procedure, or both based on whether the selected one of the set carrier bandwidths is associated with the two-step random access procedure or the four-step random access procedure.

In some examples, the random access procedure component 735 may establish the connection with the base station via the four-step random access procedure based on the second configuration message. In some examples, the random access procedure component 735 may establish the connection via the four-step random access procedure based on the link quality not satisfying the at least one of the one or more link quality thresholds.

In some examples, the random access procedure component 735 may establish the connection via the two-step random access procedure based on the link quality satisfying the at least one of the one or more link quality thresholds. The quality of service component 745 may identify that the UE is to participate in a random access procedure with a base station, where the random access procedure is for establishing a connection with the base station for a set of logical channels that have different quality of service levels.

In some examples, the quality of service component 745 may determine a quality of service associated with a logical channel for which the random access procedure is to be repeated. In some examples, the quality of service component 745 may determine an availability, a contention probability, or both associated with both the two-step random access procedure and the four-step random access procedure. In some examples, the quality of service component 745 may determine the availability, contention probability, or both associated with both the two-step random access procedure and the four-step random access procedure based on a quality of service associated with the logical channel.

In some examples, the quality of service component 745 may determine a quality of service associated with the logical channel. In some examples, the quality of service component 745 may select one of the set of carrier bandwidths based on the determined quality of service for transmission via the logical channel and the link quality associated with each of the set of carrier bandwidths.

In some examples, the quality of service component 745 may determine, an availability, a contention probability, or both associated with both the two-step random access procedure and the four-step random access procedure based on the random access rule. In some examples, the quality of service component 745 may select one of the set of carrier bandwidths based on the link quality for the higher priority logical channel.

The UE capability component 730 may determine that the UE supports the one or more transmission parameters. In some examples, the UE capability component 730 may determine that the UE does not support the one or more transmission parameters.

In some examples, the UE capability component 730 may determine that the UE supports the one or more transmission parameters, where the selection of the two-step random access procedure, the four-step random access procedure, or both is random based on determining that the UE supports the one or more transmission parameters.

The system loading information component 740 may receive, from the base station, an indication of system loading information, where the selection of the two-step random access procedure, the four-step random access procedure, or both is further based on the indication of the system loading information.

In some examples, the system loading information component 740 may receive the indication as an increase or a decrease of the one or more link quality thresholds. In some examples, the system loading information component 740 may receive the indication of system loading information via radio resource control signaling.

FIG. 8 shows a diagram of a system 800 including a device 805 that supports procedures and signaling support for RACH type selection in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a base station, a configuration message identifying one or more reference signals to be measured by the UE in determining a link quality for communications between the UE and the base station, where the configuration message also includes an identification of one or more link quality thresholds corresponding to the one or more reference signals, determine the link quality for communications between the UE and the base station based on measurements made of at least one of the one or more reference signals, compare the link quality to a corresponding at least one of the one or more link quality thresholds, and select, for establishing a connection with the base station, a two-step random access procedure, a four-step random access procedure, or both based on whether the link quality satisfies the at least one of the one or more link quality thresholds. The communications manager 810 may also identify that the UE is to participate in a random access procedure with a base station, where the random access procedure is for establishing a connection with the base station for a set of logical channels that have different quality of service levels, receive, from the base station, a configuration message identifying a random access rule for prioritizing, during the random access procedure, a higher priority logical channel of the set of logical channels, where the higher priority logical channel has a higher quality of service level than others of the set of logical channels, select, for establishing the connection with the base station, a two-step random access procedure, a four-step random access procedure, or both, based on the random access rule, and establish a connection with the base station for the higher priority logical channel in accordance with the random access rule.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only (ROM). The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting procedures and signaling support for RACH type selection).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

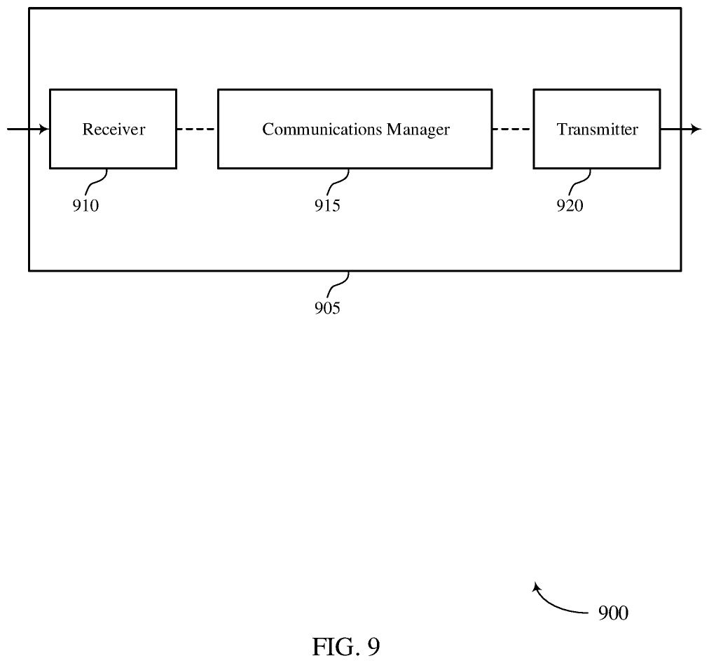

FIG. 9 shows a block diagram 900 of a device 905 that supports procedures and signaling support for RACH type selection in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

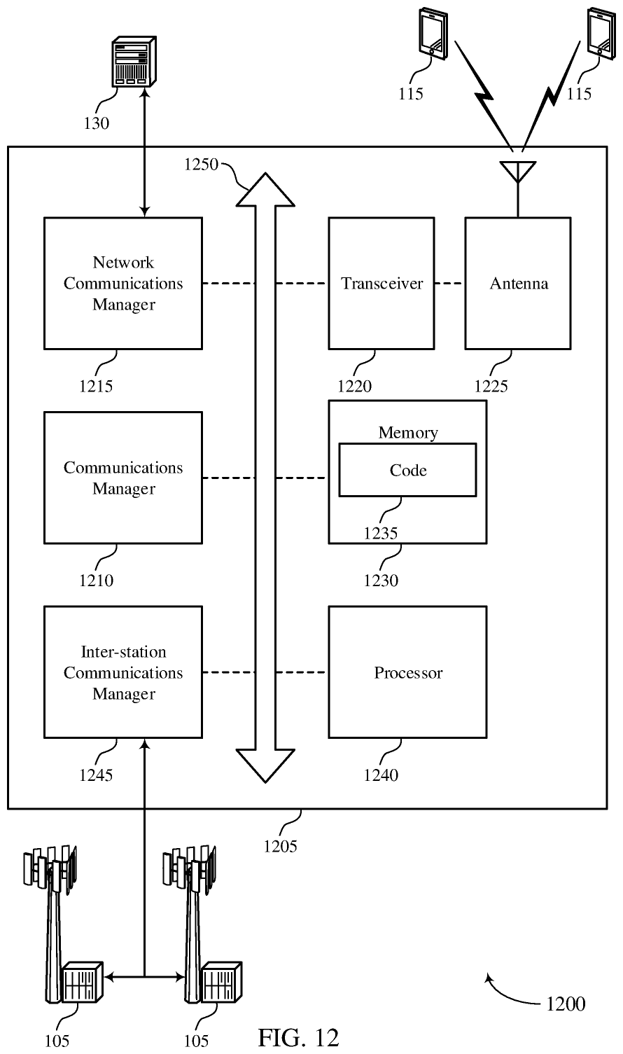

The receiver 910 may receive information such as packets, user data, or control information associated with various information channels (e.g., control channels, data channels, and information related to procedures and signaling support for RACH type selection, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may transmit, to a UE, a configuration message identifying one or more reference signals to be measured by the UE in determining a link quality for communications between the UE and the base station, where the configuration message also includes an identification of one or more link quality thresholds corresponding to the one or more reference signals and establish a connection with the UE via a two-step random access procedure, a four-step random access procedure, or both based on whether the link quality satisfies the at least one of the one or more link quality thresholds. The communications manager 915 may also transmit, to a UE, a configuration message identifying a random access rule for prioritizing, during the random access procedure, a higher priority logical channel of the set of logical channels, where the higher priority logical channel has a higher quality of service level than others of the set of logical channels and establish a connection with the UE for the higher priority logical channel in accordance with the random access rule. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

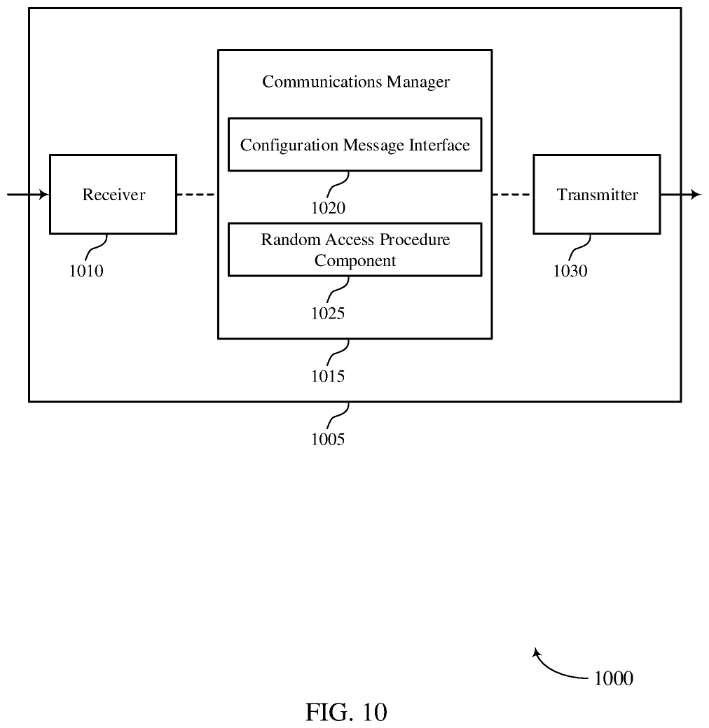

FIG. 10 shows a block diagram 1000 of a device 1005 that supports procedures and signaling support for RACH type selection in accordance with aspects of the present disclosure. The device 1005 may be an example of aspects of a device 905, or a base station 105 as described herein. The device 1005 may include a receiver 1010, a communications manager 1015, and a transmitter 1030. The device 1005 may also include a processor. Each of these components may be in communication with one another (e.g., via one or more buses).

The receiver 1010 may receive information such as packets, user data, or control information associated with various information channels (e.g., control channels, data channels, and information related to procedures and signaling support for RACH type selection, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a configuration message interface 1020 and a random access procedure component 1025. The communications manager 1015 may be an example of aspects of the communications manager 1210 described herein.

The configuration message interface 1020 may transmit, to a UE, a configuration message identifying one or more reference signals to be measured by the UE in determining a link quality for communications between the UE and the base station, where the configuration message also includes an identification of one or more link quality thresholds corresponding to the one or more reference signals.

The random access procedure component 1025 may establish a connection with the UE via a two-step random access procedure, a four-step random access procedure, or both based on whether the link quality satisfies the at least one of the one or more link quality thresholds. The configuration message interface 1020 may transmit, to a UE, a configuration message identifying a random access rule for prioritizing, during the random access procedure, a higher priority logical channel of the set of logical channels, where the higher priority logical channel has a higher quality of service level than others of the set of logical channels. The random access procedure component 1025 may establish a connection with the UE for the higher priority logical channel in accordance with the random access rule.

The transmitter 1030 may transmit signals generated by other components of the device 1005. In some examples, the transmitter 1030 may be collocated with a receiver 1010 in a transceiver module. For example, the transmitter 1030 may be an example of aspects of the transceiver 1220 described with reference to FIG. 12. The transmitter 1030 may utilize a single antenna or a set of antennas.

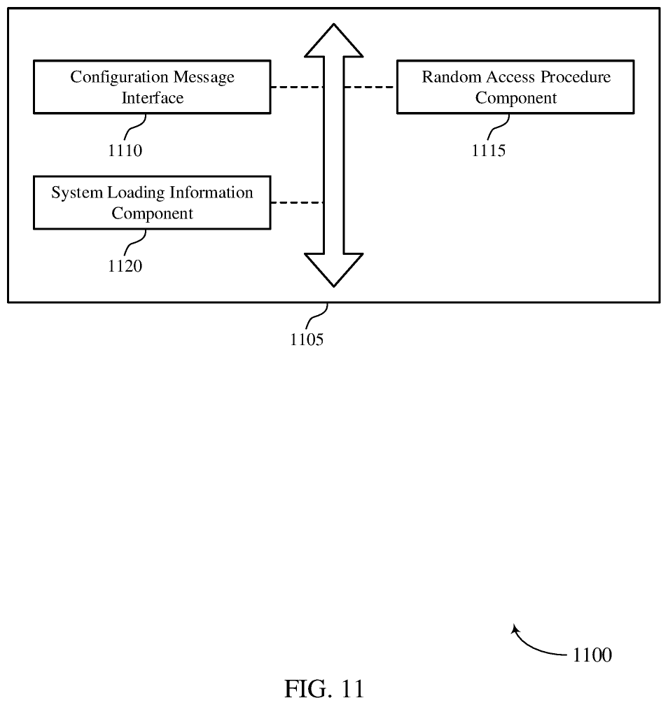

FIG. 11 shows a block diagram 1100 of a communications manager 1105 that supports procedures and signaling support for RACH type selection in accordance with aspects of the present disclosure. The communications manager 1105 may be an example of aspects of a communications manager 915, a communications manager 1015, or a communications manager 1210 described herein. The communications manager 1105 may include a configuration message interface 1110, a random access procedure component 1115, and a system loading information component 1120. Each of these modules may communicate, directly or indirectly, with one another (e.g., via one or more buses).

The configuration message interface 1110 may transmit, to a UE, a configuration message identifying one or more reference signals to be measured by the UE in determining a link quality for communications between the UE and the base station, where the configuration message also includes an identification of one or more link quality thresholds corresponding to the one or more reference signals.

In some examples, the configuration message interface 1110 may transmit, to a UE, a configuration message identifying a random access rule for prioritizing, during the random access procedure, a higher priority logical channel of the set of logical channels, where the higher priority logical channel has a higher quality of service level than others of the set of logical channels. In some examples, the configuration message interface 1110 may transmit, to the UE, the configuration message identifying one or more transmission parameters for inclusion in a first message of the two-step random access procedure. In some examples, the configuration message interface 1110 may transmit the configuration message via radio resource control signaling.

In some examples, the configuration message interface 1110 may transmit a second configuration message updating the one or more link quality thresholds corresponding to the one or more reference signals, where the connection is established with the UE based on whether the link quality satisfies at least one of the one or more updated link quality thresholds. In some examples, the configuration message interface 1110 may transmit a second configuration message indicating a selection of the four-step random access procedure, where the connection is established with the UE using the four-step random access procedure. In some cases, the one or more transmission parameters include a modulation coding scheme, a waveform, a bandwidth, a payload size, a numerology, or a combination thereof.

In some cases, the one or more reference signals to be measured include a synchronization signal block, a channel state information reference signal, a positioning reference signal, a system information block, or a combination thereof.

The random access procedure component 1115 may establish a connection with the UE via a two-step random access procedure, a four-step random access procedure, or both based on whether the link quality satisfies the at least one of the one or more link quality thresholds. In some examples, the random access procedure component 1115 may establish a connection with the UE for the higher priority logical channel in accordance with the random access rule. In some cases, the random access rule indicates establishment of the connection with the UE for the higher priority logical channel using both a two-step random access procedure and a four-step random access procedure.

In some cases, the random access rule indicates establishment of the connection with the UE for the higher priority logical channel using either a two-step random access procedure or a four-step random access procedure based on an availability, a contention probability, or both associated with both the two-step random access procedure and the four-step random access procedure based on the random access rule.

In some cases, the random access rule indicates establishment of the connection with the UE for the higher priority logical channel using either a two-step random access procedure or a four-step random access procedure based on a link quality associated with each of a set of carrier bandwidths supported by the UE.

The system loading information component 1120 may transmit, to the base station, an indication of system loading information. In some examples, the system loading information component 1120 may transmit the indication as an increase or a decrease of the one or more link quality thresholds. In some examples, the system loading information component 1120 may transmit the indication of system loading information via radio resource control signaling.

FIG. 12 shows a diagram of a system 1200 including a device 1205 that supports procedures and signaling support for RACH type selection in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may transmit, to a UE, a configuration message identifying one or more reference signals to be measured by the UE in determining a link quality for communications between the UE and the base station, where the configuration message also includes an identification of one or more link quality thresholds corresponding to the one or more reference signals and establish a connection with the UE via a two-step random access procedure, a four-step random access procedure, or both based on whether the link quality satisfies the at least one of the one or more link quality thresholds. The communications manager 1210 may also transmit, to a UE, a configuration message identifying a random access rule for prioritizing, during the random access procedure, a higher priority logical channel of the set of logical channels, where the higher priority logical channel has a higher quality of service level than others of the set of logical channels and establish a connection with the UE for the higher priority logical channel in accordance with the random access rule.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described herein. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting procedures and signaling support for RACH type selection).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

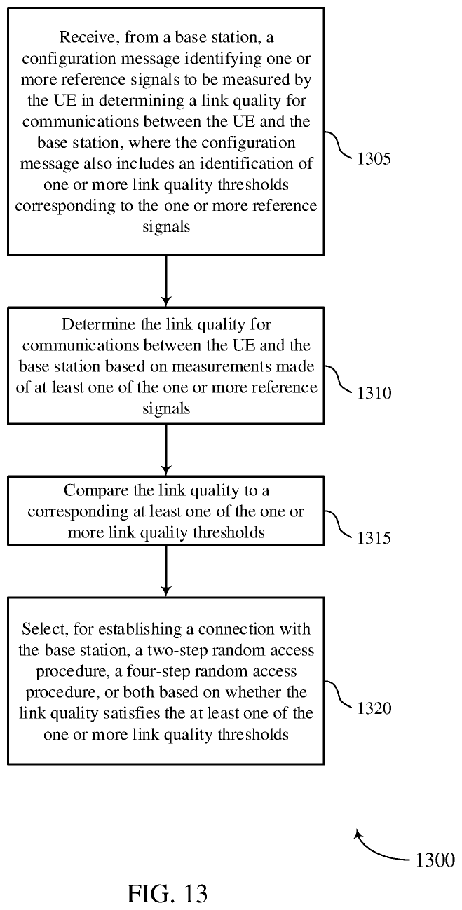

FIG. 13 shows a flowchart illustrating a method 1300 that supports procedures and signaling support for RACH type selection in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1305, the UE may receive, from a base station, a configuration message identifying one or more reference signals to be measured by the UE in determining a link quality for communications between the UE and the base station, where the configuration message also includes an identification of one or more link quality thresholds corresponding to the one or more reference signals. The operations of 1305 may be performed according to the methods described herein. In some examples, aspects of the operations of 1305 may be performed by a configuration message interface as described with reference to FIGS. 5 through 8.

At 1310, the UE may determine the link quality for communications between the UE and the base station based on measurements made of at least one of the one or more reference signals. The operations of 1310 may be performed according to the methods described herein. In some examples, aspects of the operations of 1310 may be performed by a link quality component as described with reference to FIGS. 5 through 8.

At 1315, the UE may compare the link quality to a corresponding at least one of the one or more link quality thresholds. The operations of 1315 may be performed according to the methods described herein. In some examples, aspects of the operations of 1315 may be performed by a link quality comparison component as described with reference to FIGS. 5 through 8.

At 1320, the UE may select, for establishing a connection with the base station, a two-step random access procedure, a four-step random access procedure, or both based on whether the link quality satisfies the at least one of the one or more link quality thresholds. The operations of 1320 may be performed according to the methods described herein. In some examples, aspects of the operations of 1320 may be performed by a random access procedure selection component as described with reference to FIGS. 5 through 8.

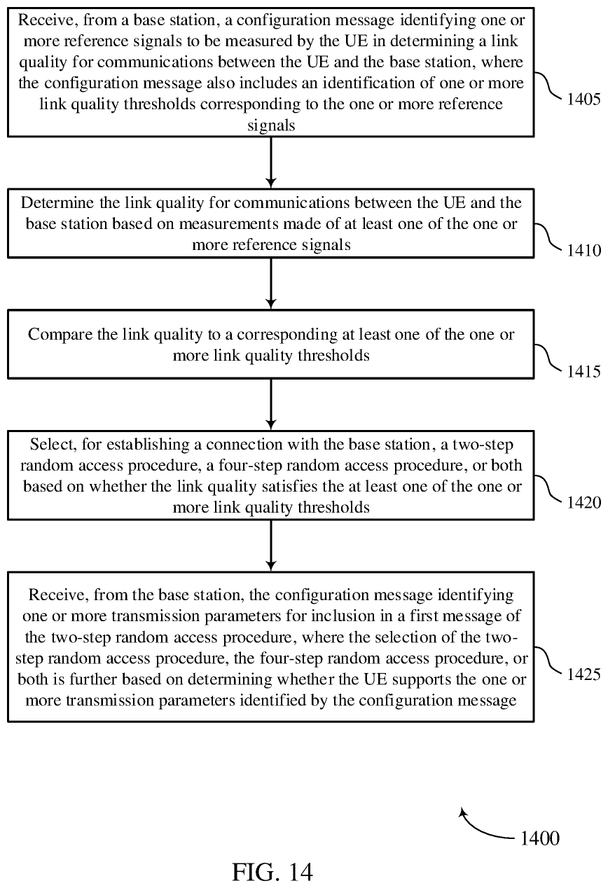

FIG. 14 shows a flowchart illustrating a method 1400 that supports procedures and signaling support for RACH type selection in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1405, the UE may receive, from a base station, a configuration message identifying one or more reference signals to be measured by the UE in determining a link quality for communications between the UE and the base station, where the configuration message also includes an identification of one or more link quality thresholds corresponding to the one or more reference signals. The operations of 1405 may be performed according to the methods described herein. In some examples, aspects of the operations of 1405 may be performed by a configuration message interface as described with reference to FIGS. 5 through 8.

At 1410, the UE may determine the link quality for communications between the UE and the base station based on measurements made of at least one of the one or more reference signals. The operations of 1410 may be performed according to the methods described herein. In some examples, aspects of the operations of 1410 may be performed by a link quality component as described with reference to FIGS. 5 through 8.

At 1415, the UE may compare the link quality to a corresponding at least one of the one or more link quality thresholds. The operations of 1415 may be performed according to the methods described herein. In some examples, aspects of the operations of 1415 may be performed by a link quality comparison component as described with reference to FIGS. 5 through 8.

At 1420, the UE may select, for establishing a connection with the base station, a two-step random access procedure, a four-step random access procedure, or both based on whether the link quality satisfies the at least one of the one or more link quality thresholds. The operations of 1420 may be performed according to the methods described herein. In some examples, aspects of the operations of 1420 may be performed by a random access procedure selection component as described with reference to FIGS. 5 through 8.

At 1425, the UE may receive, from the base station, the configuration message identifying one or more transmission parameters for inclusion in a first message of the two-step random access procedure, where the selection of the two-step random access procedure, the four-step random access procedure, or both is further based on determining whether the UE supports the one or more transmission parameters identified by the configuration message. The operations of 1425 may be performed according to the methods described herein. In some examples, aspects of the operations of 1425 may be performed by a configuration message interface as described with reference to FIGS. 5 through 8.

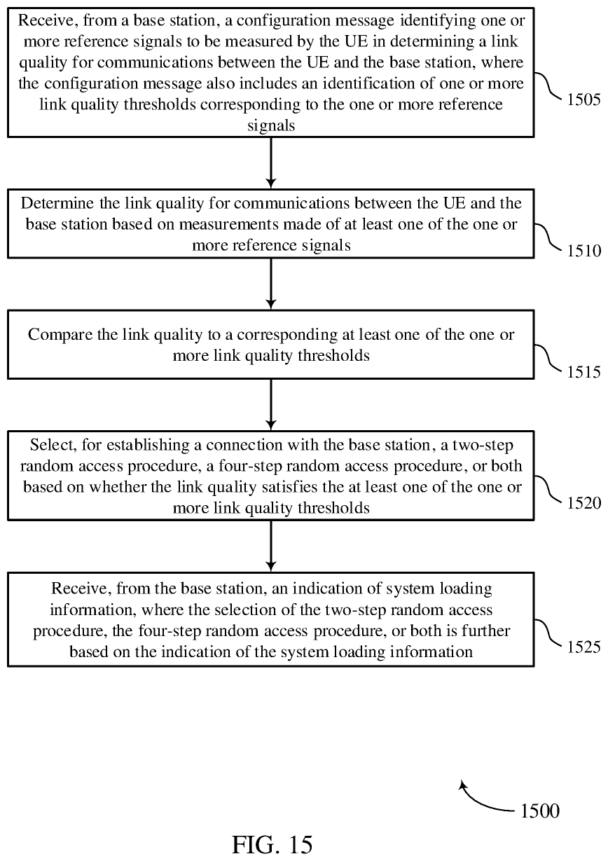

FIG. 15 shows a flowchart illustrating a method 1500 that supports procedures and signaling support for RACH type selection in accordance with aspects of the present disclosure. The operations of method 1500 may be implemented by a UE 115 or its components as described herein. For example, the operations of method 1500 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1505, the UE may receive, from a base station, a configuration message identifying one or more reference signals to be measured by the UE in determining a link quality for communications between the UE and the base station, where the configuration message also includes an identification of one or more link quality thresholds corresponding to the one or more reference signals. The operations of 1505 may be performed according to the methods described herein. In some examples, aspects of the operations of 1505 may be performed by a configuration message interface as described with reference to FIGS. 5 through 8.

At 1510, the UE may determine the link quality for communications between the UE and the base station based on measurements made of at least one of the one or more reference signals. The operations of 1510 may be performed according to the methods described herein. In some examples, aspects of the operations of 1510 may be performed by a link quality component as described with reference to FIGS. 5 through 8.

At 1515, the UE may compare the link quality to a corresponding at least one of the one or more link quality thresholds. The operations of 1515 may be performed according to the methods described herein. In some examples, aspects of the operations of 1515 may be performed by a link quality comparison component as described with reference to FIGS. 5 through 8.

At 1520, the UE may select, for establishing a connection with the base station, a two-step random access procedure, a four-step random access procedure, or both based on whether the link quality satisfies the at least one of the one or more link quality thresholds. The operations of 1520 may be performed according to the methods described herein. In some examples, aspects of the operations of 1520 may be performed by a random access procedure selection component as described with reference to FIGS. 5 through 8.

At 1525, the UE may receive, from the base station, an indication of system loading information, where the selection of the two-step random access procedure, the four-step random access procedure, or both is further based on the indication of the system loading information. The operations of 1525 may be performed according to the methods described herein. In some examples, aspects of the operations of 1525 may be performed by a system loading information component as described with reference to FIGS. 5 through 8.

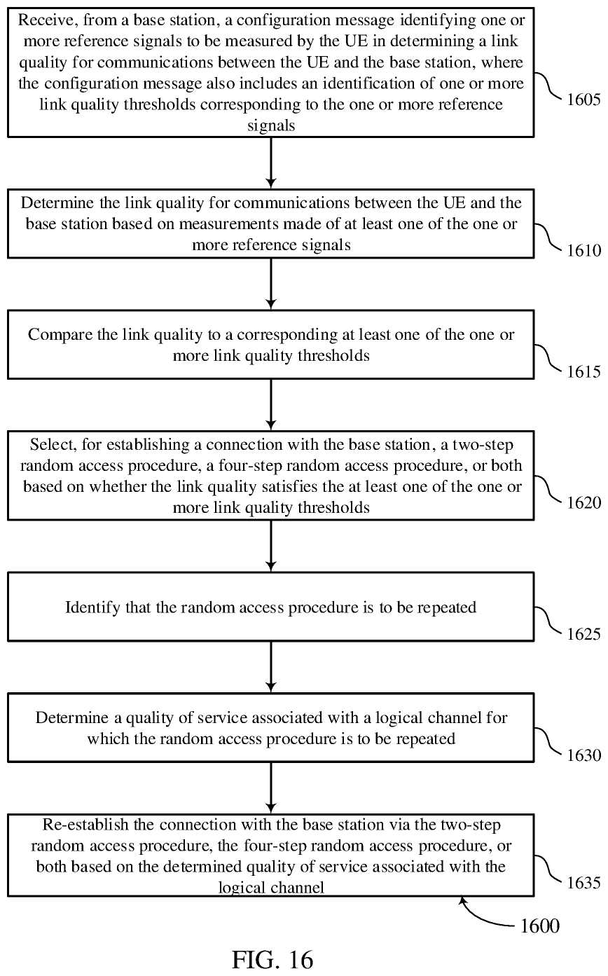

FIG. 16 shows a flowchart illustrating a method 1600 that supports procedures and signaling support for RACH type selection in accordance with aspects of the present disclosure. The operations of method 1600 may be implemented by a UE 115 or its components as described herein. For example, the operations of method 1600 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1605, the UE may receive, from a base station, a configuration message identifying one or more reference signals to be measured by the UE in determining a link quality for communications between the UE and the base station, where the configuration message also includes an identification of one or more link quality thresholds corresponding to the one or more reference signals. The operations of 1605 may be performed according to the methods described herein. In some examples, aspects of the operations of 1605 may be performed by a configuration message interface as described with reference to FIGS. 5 through 8.

At 1610, the UE may determine the link quality for communications between the UE and the base station based on measurements made of at least one of the one or more reference signals. The operations of 1610 may be performed according to the methods described herein. In some examples, aspects of the operations of 1610 may be performed by a link quality component as described with reference to FIGS. 5 through 8.

At 1615, the UE may compare the link quality to a corresponding at least one of the one or more link quality thresholds. The operations of 1615 may be performed according to the methods described herein. In some examples, aspects of the operations of 1615 may be performed by a link quality comparison component as described with reference to FIGS. 5 through 8.

At 1620, the UE may select, for establishing a connection with the base station, a two-step random access procedure, a four-step random access procedure, or both based on whether the link quality satisfies the at least one of the one or more link quality thresholds. The operations of 1620 may be performed according to the methods described herein. In some examples, aspects of the operations of 1620 may be performed by a random access procedure selection component as described with reference to FIGS. 5 through 8.

At 1625, the UE may identify that the random access procedure is to be repeated. The operations of 1625 may be performed according to the methods described herein. In some examples, aspects of the operations of 1625 may be performed by a random access procedure component as described with reference to FIGS. 5 through 8.

At 1630, the UE may determine a quality of service associated with a logical channel for which the random access procedure is to be repeated. The operations of 1630 may be performed according to the methods described herein. In some examples, aspects of the operations of 1630 may be performed by a quality of service component as described with reference to FIGS. 5 through 8.

At 1635, the UE may re-establish the connection with the base station via the two-step random access procedure, the four-step random access procedure, or both based on the determined quality of service associated with the logical channel. The operations of 1635 may be performed according to the methods described herein. In some examples, aspects of the operations of 1635 may be performed by a random access procedure component as described with reference to FIGS. 5 through 8.

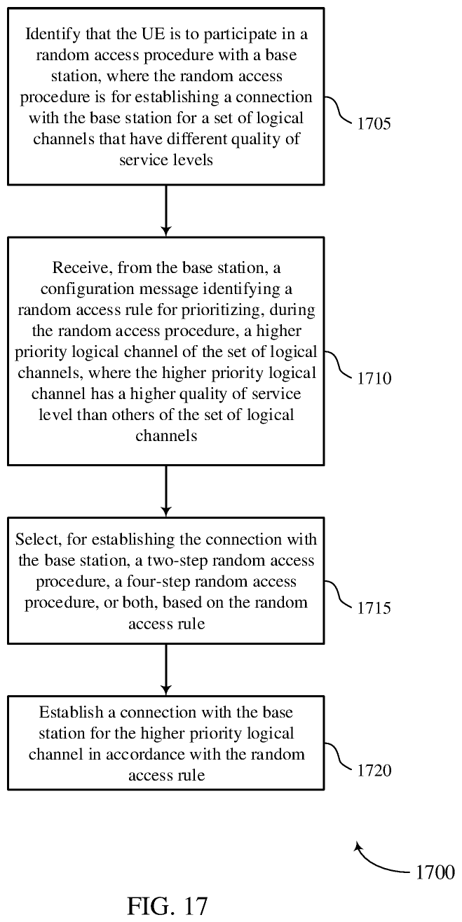

FIG. 17 shows a flowchart illustrating a method 1700 that supports procedures and signaling support for RACH type selection in accordance with aspects of the present disclosure. The operations of method 1700 may be implemented by a UE 115 or its components as described herein. For example, the operations of method 1700 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1705, the UE may identify that the UE is to participate in a random access procedure with a base station, where the random access procedure is for establishing a connection with the base station for a set of logical channels that have different quality of service levels. The operations of 1705 may be performed according to the methods described herein. In some examples, aspects of the operations of 1705 may be performed by a quality of service component as described with reference to FIGS. 5 through 8.

At 1710, the UE may receive, from the base station, a configuration message identifying a random access rule for prioritizing, during the random access procedure, a higher priority logical channel of the set of logical channels, where the higher priority logical channel has a higher quality of service level than others of the set of logical channels. The operations of 1710 may be performed according to the methods described herein. In some examples, aspects of the operations of 1710 may be performed by a configuration message interface as described with reference to FIGS. 5 through 8.

At 1715, the UE may select, for establishing the connection with the base station, a two-step random access procedure, a four-step random access procedure, or both, based on the random access rule. The operations of 1715 may be performed according to the methods described herein. In some examples, aspects of the operations of 1715 may be performed by a random access procedure selection component as described with reference to FIGS. 5 through 8.

At 1720, the UE may establish a connection with the base station for the higher priority logical channel in accordance with the random access rule. The operations of 1720 may be performed according to the methods described herein. In some examples, aspects of the operations of 1720 may be performed by a random access procedure component as described with reference to FIGS. 5 through 8.

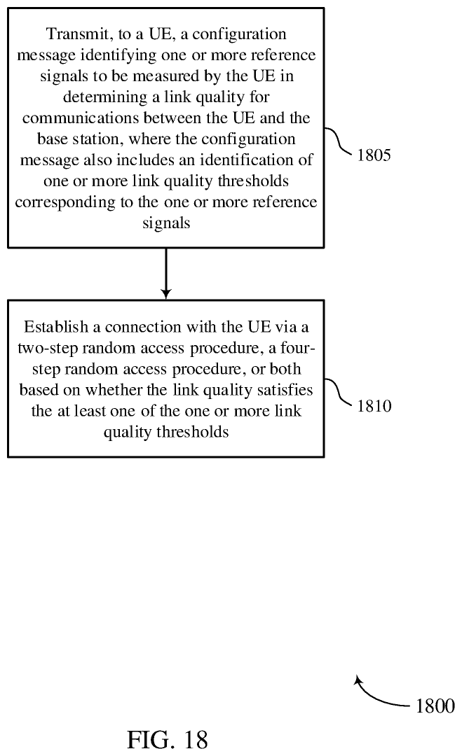

FIG. 18 shows a flowchart illustrating a method 1800 that supports procedures and signaling support for RACH type selection in accordance with aspects of the present disclosure. The operations of method 1800 may be implemented by a base station 105 or its components as described herein. For example, the operations of method 1800 may be performed by a communications manager as described with reference to FIGS. 9 through 12. In some examples, a base station may execute a set of instructions to control the functional elements of the base station to perform the functions described herein. Additionally or alternatively, a base station may perform aspects of the functions described herein using special-purpose hardware.

At 1805, the base station may transmit, to a UE, a configuration message identifying one or more reference signals to be measured by the UE in determining a link quality for communications between the UE and the base station, where the configuration message also includes an identification of one or more link quality thresholds corresponding to the one or more reference signals. The operations of 1805 may be performed according to the methods described herein. In some examples, aspects of the operations of 1805 may be performed by a configuration message interface as described with reference to FIGS. 9 through 12.

At 1810, the base station may establish a connection with the UE via a two-step random access procedure, a four-step random access procedure, or both based on whether the link quality satisfies the at least one of the one or more link quality thresholds. The operations of 1810 may be performed according to the methods described herein. In some examples, aspects of the operations of 1810 may be performed by a random access procedure component as described with reference to FIGS. 9 through 12.

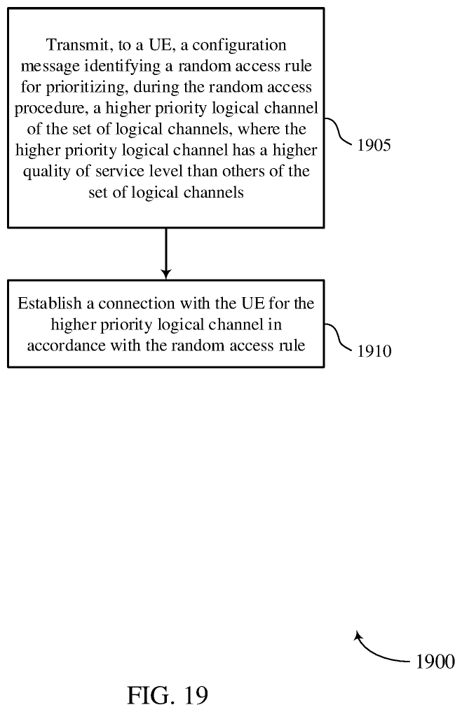

FIG. 19 shows a flowchart illustrating a method 1900 that supports procedures and signaling support for RACH type selection in accordance with aspects of the present disclosure. The operations of method 1900 may be implemented by a base station 105 or its components as described herein. For example, the operations of method 1900 may be performed by a communications manager as described with reference to FIGS. 9 through 12. In some examples, a base station may execute a set of instructions to control the functional elements of the base station to perform the functions described herein. Additionally or alternatively, a base station may perform aspects of the functions described herein using special-purpose hardware.

At 1905, the base station may transmit, to a UE, a configuration message identifying a random access rule for prioritizing, during the random access procedure, a higher priority logical channel of the set of logical channels, where the higher priority logical channel has a higher quality of service level than others of the set of logical channels. The operations of 1905 may be performed according to the methods described herein. In some examples, aspects of the operations of 1905 may be performed by a configuration message interface as described with reference to FIGS. 9 through 12.

At 1910, the base station may establish a connection with the UE for the higher priority logical channel in accordance with the random access rule. The operations of 1910 may be performed according to the methods described herein. In some examples, aspects of the operations of 1910 may be performed by a random access procedure component as described with reference to FIGS. 9 through 12.

It should be noted that the methods described herein describe possible implementations, and that the operations and the steps may be rearranged or otherwise modified and that other implementations are possible. Further, aspects from two or more of the methods may be combined.

Example 1: A method of wireless communications at a user equipment (UE), comprising: receiving, from a base station, a configuration message identifying one or more reference signals to be measured by the UE in determining a link quality for communications between the UE and the base station, wherein the configuration message also includes an identification of one or more link quality thresholds corresponding to the one or more reference signals; determining the link quality for communications between the UE and the base station based at least in part on measurements made of at least one of the one or more reference signals; comparing the link quality to a corresponding at least one of the one or more link quality thresholds; and selecting, for establishing a connection with the base station, a two-step random access procedure, a four-step random access procedure, or both based at least in part on whether the link quality satisfies the at least one of the one or more link quality thresholds.

Example 2: The method of example 1, wherein receiving, from the base station, the configuration message further comprises: receiving the configuration message via radio resource control signaling.

Example 3: The method of example 1, wherein receiving, from the base station, the configuration message further comprises: receiving the configuration message via system information signaling.

Example 4: The method of any of examples 1 to 3, further comprising: receiving, from the base station, a second configuration message updating the one or more link quality thresholds corresponding to the one or more reference signals, wherein the selection of the two-step random access procedure, the four-step random access procedure, or both is based at least in part on whether the link quality satisfies at least one of the one or more updated link quality thresholds.

Example 5: The method of any of examples 1 to 3, further comprising: receiving, from the base station, a second configuration message indicating the selection of the four-step random access procedure; and establishing the connection with the base station via the four-step random access procedure based at least in part on the second configuration message.

Example 6: The method of any of examples 1 to 5, wherein establishing the connection with the base station further comprises: establishing the connection via the four-step random access procedure based at least in part on the link quality not satisfying the at least one of the one or more link quality thresholds.

Example 7: The method of any of examples 1 to 5, wherein establishing the connection with the base station further comprises: establishing the connection via the two-step random access procedure based at least in part on the link quality satisfying the at least one of the one or more link quality thresholds.

Example 8: The method of any of examples 1 to 7, wherein the one or more reference signals to be measured comprise a synchronization signal block, a channel state information reference signal, a positioning reference signal, a system information block, or a combination thereof.

Example 9: The method of any of examples 1 to 8, wherein determining the link quality for communications between the UE and the base station comprises: determining a received signal power measurement of the one or more reference signals.

Example 10: The method of any of examples 1 to 9, further comprising: receiving, from the base station, the configuration message identifying one or more transmission parameters for inclusion in a first message of the two-step random access procedure, wherein the selection of the two-step random access procedure, the four-step random access procedure, or both is further based at least in part on determining whether the UE supports the one or more transmission parameters identified by the configuration message.

Example 11: The method of any of examples 1 to 4 and 7 to 10, further comprising: determining that the UE supports the one or more transmission parameters; and establishing the connection via the two-step random access procedure based at least in part on determining that the UE supports the one or more transmission parameters.

Example 12: The method of any of examples 1 to 6 and 8 to 10, further comprising: determining that the UE does not support the one or more transmission parameters; and establishing the connection via the four-step random access procedure based at least in part on determining that the UE does not support the one or more transmission parameters.

Example 13: The method of any of examples 1 to 12, wherein the one or more transmission parameters comprise a modulation coding scheme, a waveform, a bandwidth, a payload size, a numerology, or a combination thereof.

Example 14: The method of any of examples 1 to 13, further comprising: determining that the UE supports the one or more transmission parameters, wherein the selection of the two-step random access procedure, the four-step random access procedure, or both is random based at least in part on determining that the UE supports the one or more transmission parameters.

Example 15: The method of any of examples 1 to 14, further comprising: receiving, from the base station, an indication of system loading information, wherein the selection of the two-step random access procedure, the four-step random access procedure, or both is further based at least in part on the indication of the system loading information.

Example 16: The method of any of examples 1 to 15, wherein receiving the indication of system loading information comprises: receiving the indication as an increase or a decrease of the one or more link quality thresholds.

Example 17: The method of any of examples 1 to 16, further comprising: receiving the indication of system loading information via radio resource control signaling.

Example 18: The method of any of examples 1 to 17, further comprising: identifying that the random access procedure is to be repeated; determining a quality of service associated with a logical channel for which the random access procedure is to be repeated; and re-establishing the connection with the base station via the two-step random access procedure, the four-step random access procedure, or both based at least in part on the determined quality of service associated with the logical channel.

Example 19: The method of any of examples 1 to 18, wherein re-establishing the connection with the base station comprises: re-establishing the connection with the base station via both the two-step random access procedure and the four-step random access procedure based on determining that the quality of service associated with the logical channel satisfies a quality of service threshold.

Example 20: The method of any of examples 1 to 19, wherein re-establishing the connection with the base station comprises: determining an availability, a contention probability, or both associated with both the two-step random access procedure and the four-step random access procedure; and establishing the connection with the base station via the two-step random access procedure, the four-step random access procedure, or both based at least in part on the determined availability or the contention probability associated with the two-step random access procedure and the four-step random access procedure.

Example 21: The method of any of examples 1 to 20, further comprising: determining the availability, the contention probability, or both associated with both the two-step random access procedure and the four-step random access procedure based at least in part on the quality of service associated with the logical channel.

Example 22: The method of any of examples 1 to 21, wherein re-establishing the connection with the base station comprises: identifying a link quality associated with each of a plurality of carrier bandwidths supported by the UE; determining the quality of service associated with the logical channel; selecting one of the plurality of carrier bandwidths based on the determined quality of service for transmission via the logical channel and the link quality associated with each of the plurality of carrier bandwidths; and re-establishing the connection with the base station via the two-step random access procedure, the four-step random access procedure, or both based on whether the selected one of the plurality of carrier bandwidths is associated with the two-step random access procedure or the four-step random access procedure.

Example 23: A method of wireless communications at a base station, comprising: transmitting, to a user equipment (UE), a configuration message identifying one or more reference signals to be measured by the UE in determining a link quality for communications between the UE and the base station, wherein the configuration message also includes an identification of one or more link quality thresholds corresponding to the one or more reference signals; and establishing a connection with the UE via a two-step random access procedure, a four-step random access procedure, or both based at least in part on whether the link quality satisfies the at least one of the one or more link quality thresholds.

Example 24: The method of example 23, wherein transmitting the configuration message comprises: transmitting the configuration message via radio resource control signaling.

Example 25: The method of example 23, wherein transmitting the configuration message comprises: transmitting the configuration message via system information signaling.

Example 26: The method of examples 23 to 25, further comprising: transmitting a second configuration message updating the one or more link quality thresholds corresponding to the one or more reference signals, wherein the connection is established with the UE based at least in part on whether the link quality satisfies at least one of the one or more updated link quality thresholds.

Example 27: The method of any of examples 23 to 26, further comprising: transmitting a second configuration message indicating a selection of the four-step random access procedure, wherein the connection is established with the UE using the four-step random access procedure.

Example 28: The method of any of examples 23 to 27, wherein the one or more reference signals to be measured comprise a synchronization signal block, a channel state information reference signal, a positioning reference signal, a system information block, or a combination thereof.

Example 29: The method of any of examples 23 to 28, further comprising: transmitting, to the UE, the configuration message identifying one or more transmission parameters for inclusion in a first message of the two-step random access procedure.

Example 30: The method of example 29, wherein the one or more transmission parameters comprise a modulation coding scheme, a waveform, a bandwidth, a payload size, a numerology, or a combination thereof.

Example 31: The method of any of examples 23 to 30, further comprising: transmitting, to the base station, an indication of system loading information.

Example 32; The method of example 31, wherein transmitting the indication of system loading information comprises: transmitting the indication as an increase or a decrease of the one or more link quality thresholds.

Example 33: The method of any of examples 31 to 32, wherein transmitting the indication of system loading information comprises: transmitting the indication of system loading information via radio resource control signaling.

Example 34: The method of any of examples 23 to 33, wherein transmitting the configuration message further comprises: transmitting, to the UE, the configuration message identifying a random access rule for prioritizing, during a random access procedure, a higher priority logical channel of a plurality of logical channels, wherein the higher priority logical channel has a higher quality of service level than others of the plurality of logical channels; and establishing the connection with the UE for the higher priority logical channel in accordance with the random access rule.

Example 35: The method of example 34, wherein the random access rule indicates establishment of the connection with the UE for the higher priority logical channel using both the two-step random access procedure and the four-step random access procedure.

Example 36: The method of example 34, wherein the random access rule indicates establishment of the connection with the UE for the higher priority logical channel using either the two-step random access procedure or the four-step random access procedure based on an availability, a contention probability, or both associated with both the two-step random access procedure and the four-step random access procedure based on the random access rule.

Example 37: The method of any of examples 34 and 36, wherein the random access rule indicates establishment of the connection with the UE for the higher priority logical channel using either the two-step random access procedure or the four-step random access procedure based on a link quality associated with each of a plurality of carrier bandwidths supported by the UE.

Example 38: A method for wireless communications at a user equipment (UE), comprising: identifying that the UE is to participate in a random access procedure with a base station, wherein the random access procedure is for establishing a connection with the base station for a plurality of logical channels that have different quality of service levels; receiving, from the base station, a configuration message identifying a random access rule for prioritizing, during the random access procedure, a higher priority logical channel of the plurality of logical channels, wherein the higher priority logical channel has a higher quality of service level than others of the plurality of logical channels; selecting, for establishing the connection with the base station, a two-step random access procedure, a four-step random access procedure, or both, based at least in part on the random access rule; and establishing the connection with the base station for the higher priority logical channel in accordance with the random access rule.

Example 39: The method of example 38, wherein selecting, for establishing the connection with the base station, the two-step random access procedure, the four-step random access procedure, or both, comprises: determining to use both the two-step random access procedure and the four-step random access procedure for the higher priority logical channel based on the random access rule.

Example 40: The method of example 38, wherein selecting, for establishing the connection with the base station, the two-step random access procedure, the four-step random access procedure, or both, comprises: determining, an availability, a contention probability, or both associated with both the two-step random access procedure and the four-step random access procedure based on the random access rule; and determining, based on the random access rule, to use either the two-step random access procedure or the four-step random access procedure based at least in part on the determined availability or the contention probability associated with the two-step random access procedure and the four-step random access procedure.

Example 41: The method of any of examples 38 and 40, wherein selecting, for establishing the connection with the base station, the two-step random access procedure, the four-step random access procedure, or both, comprises: identifying, based on the random access rule, a link quality associated with each of a plurality of carrier bandwidths supported by the UE; selecting one of the plurality of carrier bandwidths based on the link quality for the higher priority logical channel; and determining, based on whether the selected one of the plurality of carrier bandwidths is associated with the two-step random access procedure or the four-step random access procedure, to use either the two-step random access procedure or the four-step random access procedure.

Example 42: A method of wireless communications at a base station, comprising: transmitting, to a user equipment (UE), a configuration message identifying a random access rule for prioritizing, during a random access procedure, a higher priority logical channel of a plurality of logical channels, wherein the higher priority logical channel has a higher quality of service level than others of the plurality of logical channels; and establishing a connection with the UE for the higher priority logical channel in accordance with the random access rule.

Example 43: The method of example 42, wherein the random access rule indicates establishment of the connection with the UE for the higher priority logical channel using both a two-step random access procedure and a four-step random access procedure.

Example 44: The method of example 42, wherein the random access rule indicates establishment of the connection with the UE for the higher priority logical channel using either a two-step random access procedure or a four-step random access procedure based on an availability, a contention probability, or both associated with both the two-step random access procedure and the four-step random access procedure based on the random access rule.

Example 45: The method of any of examples 42 and 44, wherein the random access rule indicates establishment of the connection with the UE for the higher priority logical channel using either a two-step random access procedure or a four-step random access procedure based on a link quality associated with each of a plurality of carrier bandwidths supported by the UE.

Example 46: An apparatus comprising: at least one means for performing a method of any of examples 1 to 45.

Example 47: An apparatus for wireless communications comprising a processor; memory coupled with the processor; and instructions stored in the memory and executable by the processor to cause the apparatus to perform a method of any of examples 1 to 45.

Example 48: A non-transitory computer-readable medium storing code for wireless communications, the code comprising instructions executable by a processor to perform a method of any of examples 1 to 45.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
receiving, from a base station, a configuration message identifying one or more reference signals to be measured by the UE in determining a link quality for communications between the UE and the base station, wherein the configuration message also includes an identification of one or more link quality thresholds corresponding to the one or more reference signals;
determining the link quality for communications between the UE and the base station based at least in part on measurements made of at least one of the one or more reference signals;
comparing the link quality to a corresponding at least one of the one or more link quality thresholds; and
selecting, for establishing a connection with the base station, a two-step random access procedure, a four-step random access procedure, or both based at least in part on whether the link quality satisfies the at least one of the one or more link quality thresholds.

2. The method of claim 1, wherein receiving, from the base station, the configuration message further comprises:
receiving the configuration message via radio resource control signaling.

3. The method of claim 1, wherein receiving, from the base station, the configuration message further comprises:
receiving the configuration message via system information signaling.

4. The method of claim 1, further comprising:
receiving, from the base station, a second configuration message updating the one or more link quality thresholds corresponding to the one or more reference signals, wherein the selection of the two-step random access procedure, the four-step random access procedure, or both is based at least in part on whether the link quality satisfies at least one of the one or more updated link quality thresholds.

5. The method of claim 1, further comprising:
receiving, from the base station, a second configuration message indicating the selection of the four-step random access procedure; and
establishing the connection with the base station via the four-step random access procedure based at least in part on the second configuration message.

6. The method of claim 1, wherein establishing the connection with the base station further comprises:
establishing the connection via the four-step random access procedure based at least in part on the link quality not satisfying the at least one of the one or more link quality thresholds.

7. The method of claim 1, wherein establishing the connection with the base station further comprises:
establishing the connection via the two-step random access procedure based at least in part on the link quality satisfying the at least one of the one or more link quality thresholds.

8. The method of claim 1, wherein the one or more reference signals to be measured comprise a synchronization signal block, a channel state information reference signal, a positioning reference signal, a system information block, or a combination thereof.

9. The method of claim 1, wherein determining the link quality for communications between the UE and the base station comprises:
determining a received signal power measurement of the one or more reference signals.

10. The method of claim 1, further comprising:
receiving, from the base station, the configuration message identifying one or more transmission parameters for inclusion in a first message of the two-step random access procedure, wherein the selection of the two-step random access procedure, the four-step random access procedure, or both is further based at least in part on determining whether the UE supports the one or more transmission parameters identified by the configuration message.

11. The method of claim 10, further comprising:
determining that the UE supports the one or more transmission parameters; and
establishing the connection via the two-step random access procedure based at least in part on determining that the UE supports the one or more transmission parameters.

12. The method of claim 10, further comprising:
determining that the UE does not support the one or more transmission parameters; and
establishing the connection via the four-step random access procedure based at least in part on determining that the UE does not support the one or more transmission parameters.

13. The method of claim 10, wherein the one or more transmission parameters comprise a modulation coding scheme, a waveform, a bandwidth, a payload size, a numerology, or a combination thereof.

14. The method of claim 10, further comprising:
determining that the UE supports the one or more transmission parameters, wherein the selection of the two-step random access procedure, the four-step random access procedure, or both is random based at least in part on determining that the UE supports the one or more transmission parameters.

15. The method of claim 1, further comprising:
receiving, from the base station, an indication of system loading information, wherein the selection of the two-step random access procedure, the four-step random access procedure, or both is further based at least in part on the indication of the system loading information.

16. The method of claim 15, wherein receiving the indication of system loading information comprises:
receiving the indication as an increase or a decrease of the one or more link quality thresholds.

17. The method of claim 15, further comprising:
receiving the indication of system loading information via radio resource control signaling.

18. The method of claim 1, further comprising:
identifying that a random access procedure is to be repeated;
determining a quality of service associated with a logical channel for which the random access procedure is to be repeated; and
re-establishing the connection with the base station via the two-step random access procedure, the four-step random access procedure, or both based at least in part on the determined quality of service associated with the logical channel.

19. The method of claim 18, wherein re-establishing the connection with the base station comprises:
re-establishing the connection with the base station via both the two-step random access procedure and the four-step random access procedure based on determining that the quality of service associated with the logical channel satisfies a quality of service threshold.

20. The method of claim 18, wherein re-establishing the connection with the base station comprises:
determining an availability, a contention probability, or both associated with both the two-step random access procedure and the four-step random access procedure; and
establishing the connection with the base station via the two-step random access procedure, the four-step random access procedure, or both based at least in part on the determined availability or the contention probability associated with the two-step random access procedure and the four-step random access procedure.

21. The method of claim 20, further comprising:
determining the availability, the contention probability, or both associated with both the two-step random access procedure and the four-step random access procedure based at least in part on the quality of service associated with the logical channel.

22. The method of claim 18, wherein re-establishing the connection with the base station comprises:
identifying a link quality associated with each of a plurality of carrier bandwidths supported by the UE;
determining the quality of service associated with the logical channel;
selecting one of the plurality of carrier bandwidths based on the determined quality of service for transmission via the logical channel and the link quality associated with each of the plurality of carrier bandwidths; and
re-establishing the connection with the base station via the two-step random access procedure, the four-step random access procedure, or both based on whether the selected one of the plurality of carrier bandwidths is associated with the two-step random access procedure or the four-step random access procedure.

23-37. (canceled)

38. An apparatus for wireless communications at a user equipment (UE), comprising:
a processor,
memory coupled with the processor; and
instructions stored in the memory and executable by the processor to cause the apparatus to:
receive, from a base station, a configuration message identifying one or more reference signals to be measured by the UE in determining a link quality for communications between the UE and the base station, wherein the configuration message also includes an identification of one or more link quality thresholds corresponding to the one or more reference signals;
determine the link quality for communications between the UE and the base station based at least in part on measurements made of at least one of the one or more reference signals;
compare the link quality to a corresponding at least one of the one or more link quality thresholds; and
select, for establishing a connection with the base station, a two-step random access procedure, a four-step random access procedure, or both based at least in part on whether the link quality satisfies the at least one of the one or more link quality thresholds.

39. The apparatus of claim 38, wherein the instructions to receive, from the base station, the configuration message further are executable by the processor to cause the apparatus to:
receive the configuration message via radio resource control signaling.

40. The apparatus of claim 38, wherein the instructions to receive, from the base station, the configuration message further are executable by the processor to cause the apparatus to:
receive the configuration message via system information signaling.

41. The apparatus of claim 38, wherein the instructions are further executable by the processor to cause the apparatus to:
receive, from the base station, a second configuration message updating the one or more link quality thresholds corresponding to the one or more reference signals, wherein the selection of the two-step random access procedure, the four-step random access procedure, or both is based at least in part on whether the link quality satisfies at least one of the one or more updated link quality thresholds.

42. The apparatus of claim 38, wherein the instructions are further executable by the processor to cause the apparatus to:
receive, from the base station, a second configuration message indicating the selection of the four-step random access procedure; and
establish the connection with the base station via the four-step random access procedure based at least in part on the second configuration message.

43. The apparatus of claim 38, wherein the instructions to establish the connection with the base station further are executable by the processor to cause the apparatus to:
establish the connection via the four-step random access procedure based at least in part on the link quality not satisfying the at least one of the one or more link quality thresholds.

44. The apparatus of claim 38, wherein the instructions to establish the connection with the base station further are executable by the processor to cause the apparatus to:
establish the connection via the two-step random access procedure based at least in part on the link quality satisfying the at least one of the one or more link quality thresholds.

45. The apparatus of claim 38, wherein the instructions to determine the link quality for communications between the UE and the base station are executable by the processor to cause the apparatus to:
determine a received signal power measurement of the one or more reference signals.

46. The apparatus of claim 38, wherein the instructions are further executable by the processor to cause the apparatus to:
receive, from the base station, the configuration message identifying one or more transmission parameters for inclusion in a first message of the two-step random access procedure, wherein the selection of the two-step random access procedure, the four-step random access procedure, or both is further based at least in part on determining whether the UE supports the one or more transmission parameters identified by the configuration message.

47. The apparatus of claim 46, wherein the instructions are further executable by the processor to cause the apparatus to:
determine that the UE supports the one or more transmission parameters, wherein the selection of the two-step random access procedure, the four-step random access procedure, or both is random based at least in part on determining that the UE supports the one or more transmission parameters.

48-50. (canceled)

51. An apparatus for wireless communications at a user equipment (UE), comprising:
means for receiving, from a base station, a configuration message identifying one or more reference signals to be measured by the UE in determining a link quality for communications between the UE and the base station, wherein the configuration message also includes an identification of one or more link quality thresholds corresponding to the one or more reference signals;
means for determining the link quality for communications between the UE and the base station based at least in part on measurements made of at least one of the one or more reference signals;
means for comparing the link quality to a corresponding at least one of the one or more link quality thresholds; and
means for selecting, for establishing a connection with the base station, a two-step random access procedure, a four-step random access procedure, or both based at least in part on whether the link quality satisfies the at least one of the one or more link quality thresholds.

52. (canceled)

53. A non-transitory computer-readable medium storing code for wireless communications at a user equipment (UE), the code comprising instructions executable by a processor to:
receive, from a base station, a configuration message identifying one or more reference signals to be measured by the UE in determining a link quality for communications between the UE and the base station, wherein the configuration message also includes an identification of one or more link quality thresholds corresponding to the one or more reference signals;
determine the link quality for communications between the UE and the base station based at least in part on measurements made of at least one of the one or more reference signals;
compare the link quality to a corresponding at least one of the one or more link quality thresholds; and
select, for establishing a connection with the base station, a two-step random access procedure, a four-step random access procedure, or both based at least in part on whether the link quality satisfies the at least one of the one or more link quality thresholds.

54. (canceled)
